(19) United States
(12) Patent Application Publication
(10) Pub. No.: US 2025/0158436 A1
(43) Pub. Date: May 15, 2025

(54) USB CHARGING SYSTEMS WITH OUTPUT VOLTAGES FROM AC-TO-DC CONVERTERS AND OUTPUT VOLTAGES FROM DC-TO-DC CONVERTERS

(71) Applicant: ON-BRIGHT ELECTRONICS (SHANGHAI) CO., LTD., Shanghai (CN)

(72) Inventors: GUANGWEN ZHENG, Shanghai (CN); WENJIANG WANG, Shanghai (CN); CHANGSHAN ZHANG, Shanghai (CN); ZHIQIANG WANG, Shanghai (CN)

(21) Appl. No.: 18/510,305

(22) Filed: Nov. 15, 2023

(30) Foreign Application Priority Data
Sep. 30, 2022 (CN) 202211214041.1

(51) Int. Cl. H02J 7/00

(52) U.S. Cl. CPC H02J 7/00714; H02J 2207/20

(57) ABSTRACT

Charging controller for USB charging system and method thereof. For example, a charging controller for a USB charging system includes: an AC-to-DC controller configured to generate a first signal and coupled to an AC-to-DC converter, the AC-to-DC converter being configured to convert an input voltage to a first converter voltage based on at least information associated with the first signal to output the first converter voltage as a first output voltage for a first USB output port or as a second output voltage for a second USB outport; and a DC-to-DC controller configured to generate a second signal and coupled to a DC-to-DC converter, the DC-to-DC converter being configured to convert the first converter voltage to a second converter voltage based on at least information associated with the second signal to output the second converter voltage.

### 1. CROSS-REFERENCES TO RELATED APPLICATIONS

This application claims priority to Chinese Patent Application No. 202211214041.1, filed on Sep. 30, 2022, incorporated by reference herein for all purposes.

### 2. FIELD OF THE DISCLOSURE

Certain embodiments of the present disclosure are directed to circuits. More particularly, some embodiments of the disclosure provide USB charging systems with output voltages from AC-to-DC converters and output voltages from DC-to-DC converters. Merely by way of example, some embodiments of the disclosure have been applied to two-port USB charging systems. But it would be recognized that the disclosure has a much broader range of applicability.

### 3. BACKGROUND OF THE DISCLOSURE

With the rapid development of mobile electronic devices, people increasingly use multiple mobile devices in their daily lives. If each mobile electronic device has a dedicated single-port Universal Serial Bus (USB) charging system for charging the device, it often is troublesome to carry multiple charging systems in order to charge the multiple mobile electronic devices. In response, multiport USB charging systems have emerged on the market.

Usually, a multiport USB charging system should configure the output voltage and the output current of each USB port of the charging system based on the load demand information associated with the respective USB port. For example, the load demand information includes information about the voltage and/or current needed for charging a mobile electronic device that is connected to each USB port as a load. Often, the multiport USB charging system can charge multiple mobile electronic devices simultaneously.

FIG. 1 is a simplified diagram showing a conventional two-port USB charging system implemented as an example of a conventional multiport USB charging system. The two-port USB charging system 100 includes an AC-to-DC converter 110, an optocoupler 124, a fast-charging control circuit 130, transistors 140 and 142, and USB Type-C output ports 150 and 152. The optocoupler 124 includes an optocoupler emitter 120 and an optocoupler receiver 122.

As shown in FIG. 1, the AC-to-DC converter 110 receives a voltage 109 and generates a voltage 111 (e.g., VIN) based at least in part on the voltage 109. In some examples, the voltage 109 is an AC voltage, and the voltage 111 (e.g., VIN) is a DC voltage. For example, if the transistor 140 is turned on, the voltage 111 (e.g., VIN) is used as an output voltage 141 to charge a load at the USB Type-C output port 150. As an example, if the transistor 142 is turned on, the voltage 111 (e.g., VIN) is used as an output voltage 143 to charge a load at the USB Type-C output port 152.

If a load (e.g., a mobile electronic device) is detected at only one port of the USB Type-C output port 150 and the USB Type-C output port 152 and no load is detected at the other port of the USB Type-C output port 150 and the USB Type-C output port 152, the fast-charging control circuit 130 communicates with the load (e.g., the mobile electronic device) in order to obtain the load demand information. The load demand information is provided to the AC-to-DC converter 110 through the optocoupler 124. In response, the AC-to-DC converter 110 raises and/or lowers the voltage 111 (e.g., VIN), which is used as the output voltage to charge the load (e.g., a mobile electronic device) when the transistor (e.g., the transistor 140 or the transistor 142) is turned on.

If a load (e.g., a mobile electronic device) is detected at the USB Type-C output port 150 and another load (e.g., another mobile electronic device) is detected at the USB Type-C output port 152, the fast-charging control circuit 130 cannot communicate with any of these two loads. In response, the AC-to-DC converter 110 generates a low voltage as the voltage 111 (e.g., VIN), so that each load of these two loads is charged with low voltage and low current when the transistors 140 and 142 are turned on.

If a load (e.g., a mobile electronic device) is detected at the USB Type-C output port 150 and no load is detected at the USB Type-C output port 152, the voltage 111 (e.g., VIN) is used as the output voltage 141 to charge the load (e.g., a mobile electronic device) at the USB Type-C output port 150 when the transistor 140 is turned on. Later, if another load (e.g., another mobile electronic device) is detected at the USB Type-C output port 152, the output voltage 141 drops to zero and then remains at zero for a period of time. During this period of time, the load (e.g., the mobile electronic device) at the USB Type-C output port 150 is not being charged.

FIG. 2 is a simplified diagram showing a conventional two-port USB charging system implemented as an example of a conventional multiport USB charging system. The two-port USB charging system 200 includes an AC-to-DC converter 210, inductive coils 220 and 222, fast-charging control circuits 230 and 232, transistors 240 and 242, and USB Type-C output ports 250 and 252. For example, the fast-charging control circuit 230 includes a DC-to-DC converter controller and a fast-charging-protocol unit, wherein the controller and the inductive coil 220 are parts of a DC-to-DC converter (e.g., a switching regulator unit). As an example, the fast-charging control circuit 232 includes a DC-to-DC converter controller and a fast-charging-protocol unit, wherein the controller and the inductive coil 222 are parts of a DC-to-DC converter (e.g., a switching regulator unit).

As shown in FIG. 2, the AC-to-DC converter 210 receives a voltage 209 and generates a voltage 211 (e.g., VIN) based at least in part on the voltage 209. In some examples, the voltage 209 is an AC voltage, and the voltage 211 (e.g., VIN) is a DC voltage. The voltage 211 is received by the fast-charging control circuits 230 and 232. In response, the fast-charging control circuit 230 generates a voltage 231 (e.g., a DC voltage) based at least in part on the voltage 211 (e.g., a DC voltage), and the fast-charging control circuit 232 generates a voltage 233 (e.g., a DC voltage) based at least in part on the voltage 211 (e.g., a DC voltage). For example, if the transistor 240 is turned on, the voltage 231 is used as an output voltage 241 to charge a load (e.g., a mobile electronic device) at the USB Type-C output port 250. As an example, if the transistor 242 is turned on, the voltage 233 is used as an output voltage 243 to charge a load (e.g., a mobile electronic device) at the USB Type-C output port 252.

The fast-charging control circuit 230 communicates with a load (e.g., a mobile electronic device) at the USB Type-C output port 250, and the fast-charging control circuit 232 communicates with a load (e.g., a mobile electronic device) at the USB Type-C output port 252. Each circuit of the fast-charging control circuit 230 and the fast-charging control circuit 232 includes a DC-to-DC converter controller and a fast-charging-protocol unit, and provides, together with its corresponding inductive coil (e.g., the inductive coil 220 or the inductive coil 222), an independent output voltage (e.g., the output voltage 241 or the output voltage 243) to the corresponding USB Type-C output port (e.g., the USB Type-C output port 250 or the USB Type-C output port 252) when the corresponding transistor (e.g., the transistor 240 or the transistor 242) is turned on. To prevent failure of the AC-to-DC converter 210 when both of the DC-to-DC converter (e.g., a switching regulator unit) related to the fast-charging control circuit 230 and the DC-to-DC converter (e.g., a switching regulator unit) related to the fast-charging control circuit 232 operate at their maximum power levels, the maximum output power of the AC-to-DC converter 210 needs to be greater than the sum of the maximum power levels of these two DC-to-DC converters. But if a load (e.g., a mobile electronic device) is detected at only one port of the USB Type-C output port 250 and the USB Type-C output port 252, and no load is detected at the other port of the USB Type-C output port 250 and the USB Type-C output port 252, significant power capacity of the AC-to-DC converter 210 is not utilized, wasting the extra physical size and the extra costs that are needed to support this unused power capacity.

Hence it is highly desirable to improve the technique for USB charging.

### 4. BRIEF SUMMARY OF THE DISCLOSURE

Certain embodiments of the present disclosure are directed to circuits. More particularly, some embodiments of the disclosure provide USB charging systems with output voltages from AC-to-DC converters and output voltages from DC-to-DC converters. Merely by way of example, some embodiments of the disclosure have been applied to two-port USB charging systems. But it would be recognized that the disclosure has a much broader range of applicability.

According to certain embodiments, a charging controller for a USB charging system includes: an AC-to-DC controller configured to generate a first signal and coupled to an AC-to-DC converter, the AC-to-DC converter being configured to convert an input voltage to a first converter voltage based on at least information associated with the first signal to output the first converter voltage as a first output voltage for a first USB output port or as a second output voltage for a second USB outport; and a DC-to-DC controller configured to generate a second signal and coupled to a DC-to-DC converter, the DC-to-DC converter being configured to convert the first converter voltage to a second converter voltage based on at least information associated with the second signal to output the second converter voltage as the second output voltage for the second USB outport or as the first output voltage for the first USB output port.

According to some embodiments, a charging controller for a USB charging system includes: an AC-to-DC controller configured to generate a first signal and coupled to an AC-to-DC converter configured to convert an input voltage to a first converter voltage based on at least information associated with the first signal; a DC-to-DC controller configured to generate a second signal and coupled to a DC-to-DC converter configured to convert the first converter voltage to a second converter voltage based on at least information associated with the second signal; a load demand detector coupled to the AC-to-DC controller and the DC-to-DC controller and also coupled to a first USB output port and a second USB output port, the load demand detector being configured to detect first load demand information for the first USB output port and generate a first reference voltage and a first reference current based at least in part on the first load demand information and being further configured to detect second load demand information for the second USB output port and generate a second reference voltage and a second reference current based at least in part on the second load demand information; and a load current sampling unit coupled to the AC-to-DC controller and the DC-to-DC controller and also coupled to the first USB output port and the second USB output port, the load current sampling unit being configured to receive a third signal from the load demand detector, the load current sampling unit being configured to sample a first output current for the first USB output port and generate a first feedback current based at least in part on the sampled first output current and further configured to sample a second output current for the second USB output port and generate a second feedback current based at least in part on the sampled second output current.

According to certain embodiments, a USB charging system includes: a first USB output port; a second USB output port; a charging controller including an AC-to-DC controller and a DC-to-DC controller; an AC-to-DC converter coupled to the AC-to-DC controller; a DC-to-DC converter coupled to the DC-to-DC controller; a plurality of first switches coupled to the first USB output port; and a plurality of second switches coupled to the second USB output port; wherein: the AC-to-DC controller is configured to generate a first signal; and the DC-to-DC controller is configured to generate a second signal; wherein: the AC-to-DC converter is configured to convert an input voltage to a first converter voltage based on at least information associated with the first signal; and the DC-to-DC converter is configured to convert the first converter voltage to a second converter voltage based on at least information associated with the second signal; wherein: the plurality of first switches is configured to output the first converter voltage as a first output voltage for the first USB output port through a switch of the plurality of first switches; and the plurality of second switches is configured to output the second converter voltage as a second output voltage for the second USB output port through a switch of the plurality of second switches; wherein: the plurality of second switches is further configured to output the first converter voltage as the second output voltage for the second USB output port through another switch of the plurality of second switches; and the plurality of first switches is further configured to output the second converter voltage as the first output voltage for the first USB output port through another switch of the plurality of first switches.

According to some embodiments, a USB charging system includes: a first USB output port; a second USB output port; a charging controller including an AC-to-DC controller, a DC-to-DC controller, a load demand detector, and a load current sampling unit; an AC-to-DC converter coupled to the AC-to-DC controller; and a DC-to-DC converter coupled to the DC-to-DC controller; wherein: the AC-to-DC controller is configured to generate a first signal; and the DC-to-DC controller is configured to generate a second signal; wherein: the AC-to-DC converter is configured to convert an input voltage to a first converter voltage based on at least information associated with the first signal to output the first converter voltage as a first output voltage to the first USB output port or output the first converter voltage as a second output voltage to the second USB output port; and the DC-to-DC converter is configured to convert the first converter voltage to a second converter voltage based on at least information associated with the second signal to output the second converter voltage as the second output voltage to the second USB output port or output the second converter voltage as the first output voltage to the first USB output port; wherein: the load demand detector is coupled to the AC-to-DC controller and the DC-to-DC controller and also coupled to the first USB output port and the second USB output port; and the load current sampling unit is coupled to the AC-to-DC controller and the DC-to-DC controller and also coupled to the first USB output port and the second USB output port; wherein the load demand detector is configured to: detect first load demand information for the first USB output port; generate a first reference voltage and a first reference current based at least in part on the first load demand information; detect second load demand information for the second USB output port; and generate a second reference voltage and a second reference current based at least in part on the second load demand information; wherein the load current sampling unit is configured to: receive a third signal from the load demand detector; sample a first output current for the first USB output port; generate a first feedback current based at least in part on the sampled first output current; sample a second output current for the second USB output port; and generate a second feedback current based at least in part on the sampled second output current.

According to certain embodiments, a method for a charging controller of a USB charging system includes: generating a first signal to convert an input voltage to a first converter voltage based on at least information associated with the first signal to output the first converter voltage as a first output voltage for a first USB output port or as a second output voltage for a second USB outport; and generating a second signal to convert the first converter voltage to a second converter voltage based on at least information associated with the second signal to output the second converter voltage as the second output voltage for the second USB outport or as the first output voltage for the first USB output port.

Depending upon embodiment, one or more benefits may be achieved. These benefits and various additional objects, features and advantages of the present disclosure can be fully appreciated with reference to the detailed description and accompanying drawings that follow.

### 5. BRIEF DESCRIPTION OF THE DRAWINGS

FIG. 1 is a simplified diagram showing a conventional two-port USB charging system implemented as an example of a conventional multiport USB charging system.

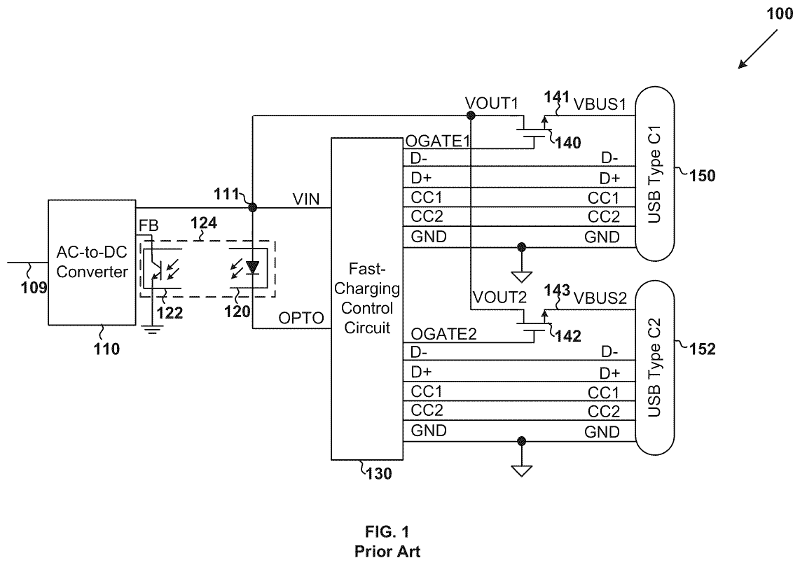

FIG. 2 is a simplified diagram showing a conventional two-port USB charging system implemented as an example of a conventional multiport USB charging system.

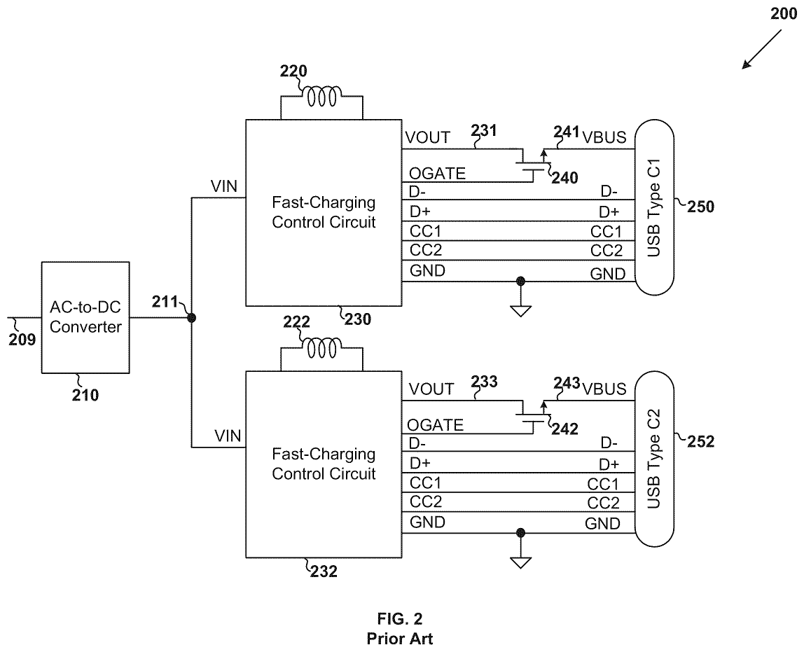

FIG. 3 is a simplified diagram showing a USB charging system according to certain embodiments of the present disclosure.

FIG. 4 is a simplified diagram showing certain components of the fast-charging control circuit as part of the USB charging system as shown in FIG. 3 according to some embodiments of the present disclosure.

FIG. 5 shows simplified timing diagrams for the USB charging system as shown in FIG. 3 and FIG. 4 according to certain embodiments of the present disclosure.

### 6. DETAILED DESCRIPTION OF THE DISCLOSURE

Certain embodiments of the present disclosure are directed to circuits. More particularly, some embodiments of the disclosure provide USB charging systems with output voltages from AC-to-DC converters and output voltages from DC-to-DC converters. Merely by way of example, some embodiments of the disclosure have been applied to two-port USB charging systems. But it would be recognized that the disclosure has a much broader range of applicability.

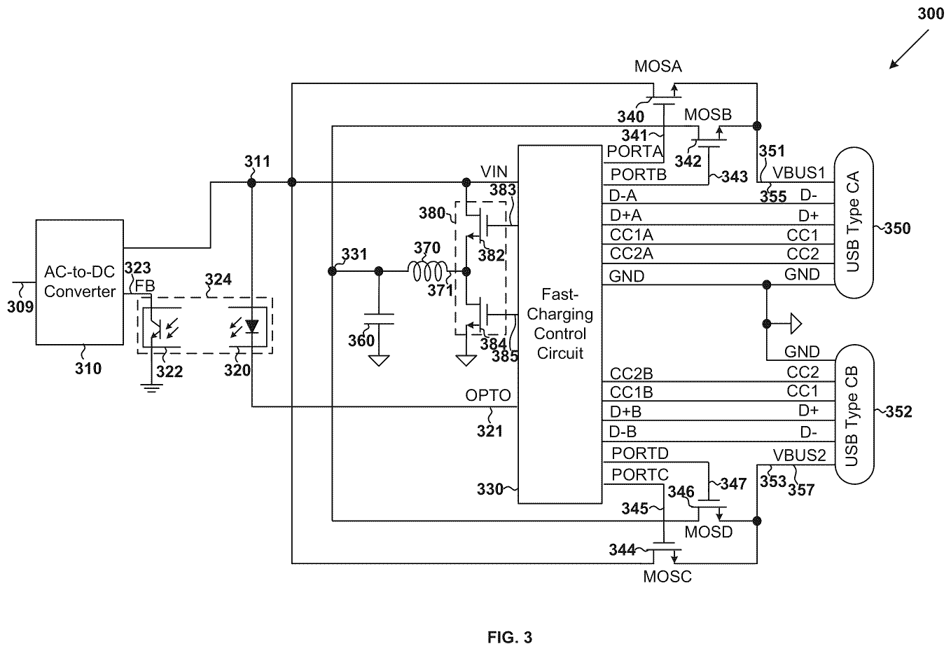

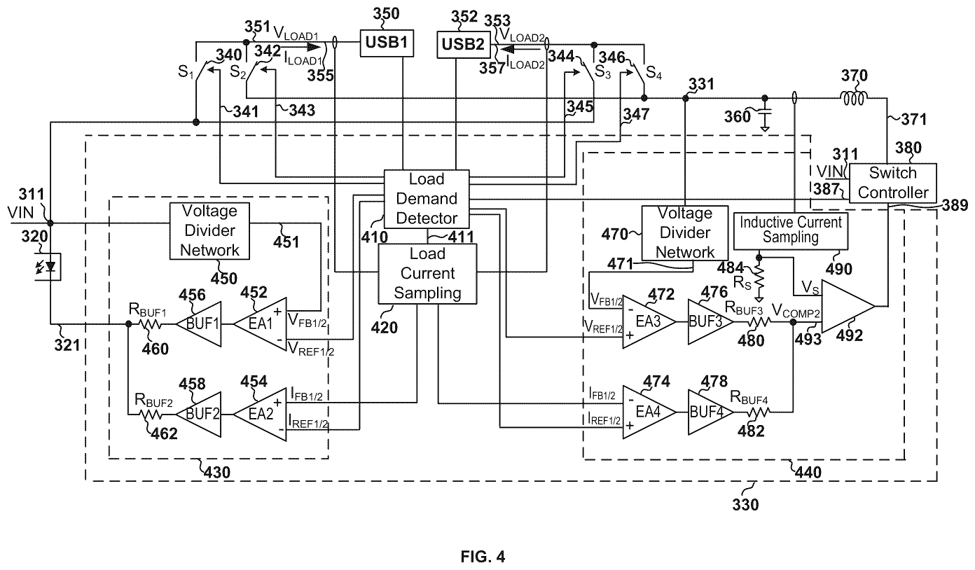

FIG. 3 is a simplified diagram showing a USB charging system according to certain embodiments of the present disclosure. This diagram is merely an example, which should not unduly limit the scope of the claims. One of ordinary skill in the art would recognize many variations, alternatives, and modifications. The USB charging system 300 (e.g., a two-port USB charging system) includes an AC-to-DC converter 310, an optocoupler 324, a fast-charging control circuit 330 (e.g., a charging controller), switches (e.g., transistors) 340, 342, 344 and 346, USB output ports 350 and 352, a capacitor 360, an inductive coil 370, and a switch controller 380. For example, the optocoupler 324 includes an optocoupler emitter 320 and an optocoupler receiver 322. As an example, the switch controller 380 includes transistors 382 and 384. In some examples, the fast-charging control circuit 330 includes a DC-to-DC converter controller, wherein the controller, the capacitor 360, the inductive coil 370, and the switch controller 380 are parts of a DC-to-DC converter (e.g., a switching regulator unit). In certain examples, the fast-charging control circuit 330 is as shown in FIG. 4. For example, the switches 340 and 342 are coupled to the USB output port 350. As an example, the switches 344 and 346 are coupled to the USB output port 352. Although the above has been shown using a selected group of components for the USB charging system, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

As shown in FIG. 3, the USB output port 350 (e.g., a USB Type-C output port or a USB Type-A output port) provides an output voltage 351 (e.g., V_{Load1}) and an output current 355 (e.g., I_{Load1}), and/or the USB output port 352 (e.g., a USB Type-C output port or a USB Type-A output port) provides an output voltage 353 (e.g., V_{Load2}) and an output current 357 (e.g., I_{Load2}) according to certain embodiments. According to some embodiments, the fast-charging control circuit 330 generates control signals 341, 343, 345 and 347. For example, the control signal 341 is used to close (e.g., turn on) and/or open (e.g., turn off) the switch 340 (e.g., a transistor). As an example, the control signal 343 is used to close (e.g., turn on) and/or open (e.g., turn off) the switch 342 (e.g., a transistor). For example, the control signal 345 is used to close (e.g., turn on) and/or open (e.g., turn off) the switch 344 (e.g., a transistor). As an example, the control signal 347 is used to close (e.g., turn on) and/or open (e.g., turn off) the switch 346 (e.g., a transistor). In certain examples, if the control signal 341 is at a logic high level, the switch 340 is closed (e.g., the transistor 340 is turned on), and if the control signal 341 is at a logic low level, the switch 340 is open (e.g., the transistor 340 is turned off). In some examples, if the control signal 343 is at a logic high level, the switch 342 is closed (e.g., the transistor 342 is turned on), and if the control signal 343 is at a logic low level, the switch 342 is open (e.g., the transistor 342 is turned off). In certain examples, if the control signal 345 is at a logic high level, the switch 344 is closed (e.g., the transistor 344 is turned on), and if the control signal 345 is at a logic low level, the switch 344 is open (e.g., the transistor 344 is turned off). In some examples, if the control signal 347 is at a logic high level, the switch 346 is closed (e.g., the transistor 346 is turned on), and if the control signal 347 is at a logic low level, the switch 346 is open (e.g., the transistor 346 is turned off).

In some embodiments, the AC-to-DC converter 310 receives a voltage 309 (e.g., an input voltage) and generates a voltage 311 (e.g., VIN) based at least in part on the voltage 309 according to some embodiments. In certain examples, the voltage 309 is an AC voltage, and the voltage 311 (e.g., VIN) is a DC voltage. For example, if the switch 340 is closed and the switch 342 is open (e.g., if the transistor 340 is turned on and the transistor 342 is turned off), the voltage 311 (e.g., VIN) is used as the output voltage 351 to charge a load at the USB output port 350 (e.g., a USB Type-C output port or a USB Type-A output port). As an example, if the switch 344 is closed and the switch 346 is open (e.g., if the transistor 344 is turned on and the transistor 346 is turned off), the voltage 311 (e.g., VIN) is used as the output voltage 353 to charge a load at the USB output port 352 (e.g., a USB Type-C output port or a USB Type-A output port).

In certain embodiments, the fast-charging control circuit 330 receives the voltage 311 (e.g., VIN) and with the capacitor 360, the inductive coil 370, and the switch controller 380, generates a voltage 331 based at least in part on the voltage 311 (e.g., VIN). For example, the voltage 311 (e.g., VIN) is a DC voltage, and the voltage 331 is a DC voltage. In some examples, the voltage 331 is less than or equal to the voltage 311 (e.g., VIN). For example, if the switch 340 is open and the switch 342 is closed (e.g., if the transistor 340 is turned off and the transistor 342 is turned on), the voltage 331 is used as the output voltage 351 to charge the load at the USB output port 350 (e.g., a USB Type-C output port or a USB Type-A output port). As an example, if the switch 344 is open and the switch 346 is closed (e.g., if the transistor 344 is turned off and the transistor 346 is turned on), the voltage 331 is used as the output voltage 353 to charge the load at the USB output port 352 (e.g., a USB Type-C output port or a USB Type-A output port).

According to some embodiments, the switch controller 380 includes the switches (e.g., transistors) 382 and 384. In certain examples, the switch controller 380 receive control signals 383 and 385, which are generated by the fast-charging control circuit 330. For example, the control signal 383 is used to close (e.g., turn on) and/or open (e.g., turn off) the switch 382 (e.g., the transistor 382). As an example, the control signal 385 is used to close (e.g., turn on) and/or open (e.g., turn off) the switch 384 (e.g., the transistor 384). In some examples, the switch controller 380 also receives the voltage 311 (e.g., VIN). For example, the switch 382 (e.g., the transistor 382) receives the voltage 311 (e.g., VIN). As an example, the switch controller 380 generates a voltage 371 based at least in part on the voltage 311 (e.g., VIN), the control signal 383, and the control signal 385. According to certain embodiments, the voltage 371 is received by the inductive coil 370. For example, the inductive coil 370 generates, with the capacitor 360, the voltage 331 based at least in part on the voltage 371.

In some embodiments, the fast-charging control circuit 330 generates a control signal 321. For example, the fast-charging control circuit 330 includes an optocoupler drive circuit. As an example, the optocoupler drive circuit is configured to drive the optocoupler 324 in order to generate a feedback signal 323. In certain examples, the feedback signal 323 is received by the AC-to-DC converter 310. For example, the AC-to-DC converter 310 generates the voltage 311 (e.g., VIN) based at least in part on the feedback signal 323. As an example, the AC-to-DC converter 310 converts the voltage 309 (e.g., an input voltage) to the voltage 311 (e.g., VIN) based on at least information associated with the control signal 321.

FIG. 4 is a simplified diagram showing certain components of the fast-charging control circuit 330 as part of the USB charging system 300 as shown in FIG. 3 according to some embodiments of the present disclosure. This diagram is merely an example, which should not unduly limit the scope of the claims. One of ordinary skill in the art would recognize many variations, alternatives, and modifications. The fast-charging control circuit 330 (e.g., a charging controller) includes a load demand detector 410, a load current sampling unit 420, an AC-to-DC controller 430, and a DC-to-DC controller 440. In some examples, the capacitor 360, the inductive coil 370, and the switch controller 380 are parts of a DC-to-DC converter (e.g., a switching regulator unit). For example, the DC-to-DC controller 440 is not part of the DC-to-DC converter (e.g., a switching regulator unit). As an example, the DC-to-DC controller 440 is coupled to the DC-to-DC converter. For example, the DC-to-DC controller 440 is used to control the DC-to-DC converter (e.g., a switching regulator unit). In certain examples, the AC-to-DC controller 430 is not part of the AC-to-DC converter 310. Although the above has been shown using a selected group of components for the fast-charging control circuit, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

According to certain embodiments, the load demand detector 410 generates the control signals 341, 343, 345 and 347. For example, the control signal 341 is used to close (e.g., turn on) and/or open (e.g., turn off) the switch 340 (e.g., a transistor). As an example, the control signal 343 is used to close (e.g., turn on) and/or open (e.g., turn off) the switch 342 (e.g., a transistor). For example, the control signal 345 is used to close (e.g., turn on) and/or open (e.g., turn off) the switch 344 (e.g., a transistor). As an example, the control signal 347 is used to close (e.g., turn on) and/or open (e.g., turn off) the switch 346 (e.g., a transistor). In some examples, the load demand detector 410 is coupled to the USB output port 350 and the USB output port 352.

In certain embodiments, the AC-to-DC controller 430 includes a voltage divider network 450, error amplifiers 452 and 454, buffers 456 and 458, and resistors 460 and 462. For example, the error amplifiers 452 and 454 and the buffers 456 and 458 are parts of a control loop. As an example, the buffers 456 and 458 and the resistors 460 and 462 are parts of the optocoupler drive circuit of the fast-charging control circuit 330. In some examples, the voltage divider network 450 receives the voltage 311 (e.g., VIN) and generates a feedback voltage 451 based at least in part on the voltage 311 (e.g., VIN). For example, the voltage 451 is used as the feedback voltage V_{FB1} that represents the output voltage 351 (e.g., V_{Load1}) if the switch 340 is closed and the switch 344 is open. As an example, the voltage 451 is used as the feedback voltage V_{FB2} that represents the output voltage 353 (e.g., V_{Load2}) if the switch 340 is open and the switch 344 is closed. In certain examples, the control loop, including the error amplifiers 452 and 454 and the buffers 456 and 458, receives the voltage 451 and generates the control signal 321 based at least in part on a reference voltage (e.g., V_{REF1} or V_{REF2}), a reference current (e.g., I_{REF1} or I_{REF2}), a feedback current (e.g., I_{FB1} or I_{FB2}), and a feedback voltage (e.g., V_{FB1} or V_{FB2}). For example, the control signal 321 is used by at least the optocoupler 324 to generate the feedback signal 323. As an example, the error amplifier 454 receives a voltage that represents a feedback current (e.g., I_{FB1} or I_{FB2}) and also receives a voltage that represents a reference current (e.g., I_{REF1} or I_{REF2}).

In some embodiments, the load demand detector 410 detects the load demand information (e.g., Load Demand 1) for the USB output port 350 (e.g., a USB Type-C output port or a USB Type-A output port) and/or the load demand information (e.g., Load Demand 2) for the USB output port 352 (e.g., a USB Type-C output port or a USB Type-A output port). For example, the load demand information (e.g., Load Demand 1) for the USB output port 350 includes a detected load demand voltage for the USB output port 350 and/or a detected load demand current for the USB output port 350. As an example, the load demand information (e.g., Load Demand 2) for the USB output port 352 includes a detected load demand voltage for the USB output port 352 and/or a detected load demand current for the USB output port 352.

According to certain embodiments, the reference voltage V_{REF1} represents the detected load demand voltage for the USB output port 350, and the reference voltage V_{REF2} represents the detected load demand voltage for the USB output port 352. For example, if the reference voltage V_{REF1} is larger than the reference voltage V_{REF2}, the detected load demand voltage for the USB output port 350 is larger than the detected load demand voltage for the USB output port 352. As an example, if the reference voltage V_{REF1} is equal to the reference voltage V_{REF2}, the detected load demand voltage for the USB output port 350 is equal to the detected load demand voltage for the USB output port 352. For example, if the reference voltage V_{REF1} is smaller than the reference voltage V_{REF2}, the detected load demand voltage for the USB output port 350 is smaller than the detected load demand voltage for the USB output port 352.

According to some embodiments, the reference current I_{REF1} represents the detected load demand current for the USB output port 350, and the reference current I_{REF2} represents the detected load demand current for the USB output port 352. For example, if the reference current I_{REF1} is larger than the reference current I_{REF2}, the detected load demand current for the USB output port 350 is larger than the detected load demand current for the USB output port 352. As an example, if the reference current I_{REF1} is equal to the reference current I_{REF2}, the detected load demand current for the USB output port 350 is equal to the detected load demand current for the USB output port 352. For example, if the reference current I_{REF1} is smaller than the reference current I_{REF2}, the detected load demand current for the USB output port 350 is smaller than the detected load demand current for the USB output port 352.

According to some embodiments, the DC-to-DC controller 440 includes a voltage divider network 470, error amplifiers 472 and 474, buffers 476 and 478, resistors 480, 482 and 484, an inductive current sampling unit 490, and a comparator 492. For example, the error amplifiers 472 and 474 and the buffers 476 and 478 are parts of a control loop. In some examples, the voltage divider network 470 receives the voltage 331 and generates a feedback voltage 471 based at least in part on the voltage 331. For example, the voltage 471 is used as the feedback voltage V_{FB1} if the switch 342 is closed and the switch 346 is open. As an example, the voltage 471 is used as the feedback voltage V_{FB2} if the switch 342 is open and the switch 346 is closed. In certain examples, the control loop, including the error amplifiers 472 and 474 and the buffers 476 and 478, receives the voltage 471 and generates a signal 493 based at least in part on a reference voltage (e.g., V_{REF1} or V_{REF2}), a reference current (e.g., I_{REF1} or I_{REF2}), a feedback current (e.g., I_{FB1} or I_{FB2}), and a feedback voltage (e.g., V_{FB1} or V_{FB2}). For example, the signal 493 is used by at least the comparator 492 (e.g., a pulse-width-modulation comparator) to generate the signal 389. As an example, the error amplifier 474 receives a voltage that represents a feedback current (e.g., I_{FB1} or I_{FB2}) and also receives a voltage that represents a reference current (e.g., I_{REF1} or I_{REF2}).

In certain embodiments, the load demand detector 410 detects the load demand information (e.g., Load Demand 1) for the USB output port 350 (e.g., a USB Type-C output port or a USB Type-A output port) and/or the load demand information (e.g., Load Demand 2) for the USB output port 352 (e.g., a USB Type-C output port or a USB Type-A output port). In some examples, the load demand detector 410 communicates with a load (e.g., a mobile electronic device) that is connected to the USB output port 350 (e.g., a USB Type-C output port or a USB Type-A output port) in order to obtain the load demand information (e.g., Load Demand 1) based at least in part on a charging protocol. For example, the load demand detector 410 communicates with a load that is connected to the USB output port 350 based at least in part on a quick charging (QC) protocol. As an example, the load demand detector 410 communicates with a load that is connected to the USB output port 350 based at least in part on a firewall communication protocol (FCP). For example, the load demand detector 410 communicates with a load that is connected to the USB output port 350 based at least in part on an adaptive fast charging (AFC) protocol. As an example, the load demand detector 410 communicates with a load that is connected to the USB output port 350 based at least in part on a standard communication protocol (SCP). For example, the load demand detector 410 communicates with a load that is connected to the USB output port 350 based at least in part on a power delivery (PD) protocol. In certain examples, the load demand detector 410 communicates with a load (e.g., a mobile electronic device) that is connected to the USB output port 352 (e.g., a USB Type-C output port or a USB Type-A output port) in order to obtain the load demand information (e.g., Load Demand 2) based at least in part on a charging protocol. For example, the load demand detector 410 communicates with a load that is connected to the USB output port 352 based at least in part on a quick charging (QC) protocol. As an example, the load demand detector 410 communicates with a load that is connected to the USB output port 352 based at least in part on a firewall communication protocol (FCP). For example, the load demand detector 410 communicates with a load that is connected to the USB output port 352 based at least in part on an adaptive fast charging (AFC) protocol. As an example, the load demand detector 410 communicates with a load that is connected to the USB output port 352 based at least in part on a standard communication protocol (SCP). For example, the load demand detector 410 communicates with a load that is connected to the USB output port 352 based at least in part on a power delivery (PD) protocol.

In some embodiments, based at least in part on the detected load demand information (e.g., Load Demand 1) for the USB output port 350, the load demand detector 410 is further configured to generate a reference voltage (e.g., V_{REF1}) and a reference current (e.g., I_{REF1}). For example, the reference voltage (e.g., V_{REF1}) represents the detected load demand voltage for the USB output port 350. As an example, the reference current (e.g., I_{REF1}) represents the detected load demand current for the USB output port 350. In some embodiments, based at least in part on the detected load demand information (e.g., Load Demand 2) for the USB output port 352, the load demand detector 410 is further configured to generate a reference voltage (e.g., V_{REF2}) and a reference current (e.g., I_{REF2}). For example, the reference voltage (e.g., V_{REF2}) represents the detected load demand voltage for the USB output port 352. As an example, the reference current (e.g., I_{REF2}) represents the detected load demand current for the USB output port 352. In some examples, the AC-to-DC controller 430 receives a reference voltage (e.g., V_{REF1} or V_{REF2}) and a voltage that represents a reference current (e.g., I_{REF1} or I_{REF2}). In certain examples, the DC-to-DC controller 440 receives a reference voltage (e.g., V_{REF1} or V_{REF2}) and a voltage that represents a reference current (e.g., I_{REF1} or I_{REF2}).

In certain embodiments, the load current sampling unit 420 samples the output current 355 at the USB output port 350 and generates a feedback current (e.g., I_{FB1}) based at least in part on the sampled output current 355, and/or the load current sampling unit 420 samples the output current 357 at the USB output port 352 and generates a feedback current (e.g., I_{FB2}) based at least in part on the sampled output current 357. For example, the feedback current (e.g., I_{FB1}) represents the output current 355 (e.g., I_{Load1}). As an example, the feedback current (e.g., I_{FB2}) represents the output current 357 (e.g., I_{Load2}). In certain examples, the AC-to-DC controller 430 receives a voltage that represents a feedback current (e.g., I_{FB1} or I_{FB2}). In certain examples, the DC-to-DC controller 440 receives a voltage that represents a feedback current (e.g., I_{FB1} or I_{FB2}).

According to some embodiments, in addition to receiving a reference voltage (e.g., V_{REF1} or V_{REF2}) and a voltage that represents a reference current (e.g., I_{REF1} or I_{REF2}) from the load demand detector 410 and receiving a voltage that represents a feedback current (e.g., I_{FB1} or I_{FB2}) from the load current sampling unit 420, the AC-to-DC controller 430 also obtains a feedback voltage (e.g., V_{FB1} or V_{FB2}). For example, based at least in part on the reference voltage (e.g., V_{REF1} or V_{REF2}), the reference current (e.g., I_{REF1} or I_{REF2}), the feedback current (e.g., I_{FB1} or I_{FB2}), and the feedback voltage (e.g., V_{FB1} or V_{FB2}), the AC-to-DC controller 430 generates the control signal 321, which is used to generate the feedback signal 323 by at least the optocoupler 324 as shown in FIG. 3. In certain examples, the AC-to-DC controller 430 is coupled to the AC-to-DC converter 310 through the optocoupler 324. As an example, the AC-to-DC converter 310 receives the feedback signal 323 and generates the voltage 311 (e.g., VIN) based at least in part on the feedback signal 323. For example, the optocoupler 324 is coupled to the AC-to-DC controller 430 and the AC-to-DC converter 310.

According to certain embodiments, in addition to receiving the reference voltage (e.g., V_{REF1} or V_{REF2}) and a voltage that represents the reference current (e.g., I_{REF1} or I_{REF2}) from the load demand detector 410 and receiving a voltage that represents a feedback current (e.g., I_{FB1} or I_{FB2}) from the load current sampling unit 420, the DC-to-DC controller 440 also obtains the feedback voltage 451 (e.g., V_{FB1} or V_{FB2}). For example, based at least in part on the reference voltage (e.g., V_{REF1} or V_{REF2}), the reference current (e.g., I_{REF1} or I_{REF2}), the feedback current (e.g., I_{FB1} or I_{FB2}), and the feedback voltage (e.g., V_{FB1} or V_{FB2}), the DC-to-DC controller 440 generates, with the capacitor 360, the inductive coil 370 and the switch controller 380, the voltage 331. As an example, the voltage 331 is less than or equal to the voltage 311 (e.g., VIN). In some examples, the AC-to-DC controller 430 and/or the DC-to-DC controller 440 compares the output voltage 351 (e.g., V_{Load1}) and the detected load demand voltage for the USB output port 350 by comparing the feedback voltage V_{FB1} and the reference voltage V_{REF1}. For example, if the feedback voltage V_{FB1} is larger than the reference voltage V_{REF1}, the output voltage 351 (e.g., V_{Load1}) is larger than the detected load demand voltage for the USB output port 350. As an example, if the feedback voltage V_{FB1} is equal to the reference voltage V_{REF1}, the output voltage 351 (e.g., V_{Load1}) is equal to the detected load demand voltage for the USB output port 350. For example, if the feedback voltage V_{FB1} is smaller than the reference voltage V_{REF1}, the output voltage 351 (e.g., V_{Load1}) is smaller than the detected load demand voltage for the USB output port 350.

In certain examples, the AC-to-DC controller 430 and/or the DC-to-DC controller 440 compares the output voltage 353 (e.g., V_{Load2}) and the detected load demand voltage for the USB output port 352 by comparing the feedback voltage V_{FB2} and the reference voltage V_{REF2}. For example, if the feedback voltage V_{FB2} is larger than the reference voltage V_{REF2}, the output voltage 353 (e.g., V_{Load2}) is larger than the detected load demand voltage for the USB output port 352. As an example, if the feedback voltage V_{FB2} is equal to the reference voltage V_{REF2}, the output voltage 353 (e.g., V_{Load2}) is equal to the detected load demand voltage for the USB output port 352. For example, if the feedback voltage V_{FB2} is smaller than the reference voltage V_{REF2}, the output voltage 353 (e.g., V_{Load2}) is smaller than the detected load demand voltage for the USB output port 352.

In some examples, the AC-to-DC controller 430 and/or the DC-to-DC controller 440 compares the output current 355 (e.g., I_{Load1}) and the detected load demand current for the USB output port 350 by comparing the feedback current I_{FB1} and the reference current I_{REF1}. For example, if the feedback current I_{FB1} is larger than the reference current I_{REF1}, the output current 355 (e.g., I_{Load1}) is larger than the detected load demand current for the USB output port 350. As an example, if the feedback current I_{FB1} is equal to the reference current I_{REF1}, the output current 355 (e.g., I_{Load1}) is equal to the detected load demand current for the USB output port 350. For example, if the feedback current I_{FB1} is smaller than the reference current I_{REF1}, the output current 355 (e.g., I_{Load1}) is smaller than the detected load demand current for the USB output port 350.

In some examples, the AC-to-DC controller 430 and/or the DC-to-DC controller 440 compares the output current 357 (e.g., I_{Load2}) and the detected load demand current for the USB output port 352 by comparing the feedback current I_{FB2} and the reference current I_{REF2}. For example, if the feedback current I_{FB2} is larger than the reference current I_{REF2}, the output current 357 (e.g., I_{Load2}) is larger than the detected load demand current for the USB output port 352. As an example, if the feedback current I_{FB2} is equal to the reference current I_{REF2}, the output current 357 (e.g., I_{Load2}) is equal to the detected load demand current for the USB output port 352. For example, if the feedback current I_{FB2} is smaller than the reference current I_{REF2}, the output current 357 (e.g., I_{Load2}) is smaller than the detected load demand current for the USB output port 352.

In some embodiments, the load demand detector 410 generates a signal 387, and the DC-to-DC controller 440 generates a signal 389. In some examples, both the signals 387 and 389 are received by the switch controller 380. For example, the signal 387 is used to enable and/or disable the switch controller 380. As an example, if the switch controller 380 is disabled by the signal 387, the switch 382 and the switch 384 are both open. In certain examples, when the switch controller 380 is enabled, if the signal 389 changes from a logic low level to a logic high level, the signal 383 is changed so that the switch 382 becomes open (e.g., the transistor 382 becomes turned off), and the signal 385 is changed so that the switch 384 becomes closed (e.g., the transistor 384 becomes turned on). In some examples, the switch controller 380 also receives the voltage 311 (e.g., VIN) generated by the AC-to-DC converter 310. For example, the switch controller 380 generates the voltage 371 based at least in part on the voltage 311 (e.g., VIN), the signal 387, and the signal 389. In certain examples, the DC-to-DC converter, which includes the capacitor 360, the inductive coil 370, and the switch controller 380, converts the voltage 311 (e.g., VIN) to the voltage 331 based on at least information associated with the signal 389.

In certain embodiments, if the switch 340 is closed, the switch 342 is open, the switch 344 is open, and the switch 346 is closed, the voltage 311 (e.g., VIN) is used as the output voltage 351 to charge a load at the USB output port 350 (e.g., a USB Type-C output port or a USB Type-A output port), and the voltage 331 is used as the output voltage 353 to charge the load at the USB output port 352 (e.g., a USB Type-C output port or a USB Type-A output port). In some examples, when the switch 340 is closed, the switch 342 is open, the switch 344 is open and the switch 346 is closed, the AC-to-DC controller 430 receives the reference voltage V_{REF1} and a voltage that represents the reference current I_{REF1}, and the DC-to-DC controller 440 receives the reference voltage V_{REF2} and a voltage that represents the reference current I_{REF2}. For example, the reference voltage V_{REF1} and the reference current I_{REF1} are generated based at least in part on the detected load demand information (e.g., Load Demand 1) for the USB output port 350. As an example, the reference voltage V_{REF2} and the reference current I_{REF2} are generated based at least in part on the detected load demand information (e.g., Load Demand 2) for the USB output port 352. In certain examples, when the switch 340 is closed, the switch 342 is open, the switch 344 is open and the switch 346 is closed, the AC-to-DC controller 430 also receives a voltage that represents the feedback current I_{FB1}, and the DC-to-DC controller 440 also receives a voltage that represents the feedback current I_{FB2}. For example, the feedback current I_{FB1} is generated based at least in part on the output current 355 at the USB output port 350. As an example, the feedback current I_{FB2} is generated based at least in part on the output current 357 at the USB output port 352. In some examples, when the switch 340 is closed, the switch 342 is open, the switch 344 is open and the switch 346 is closed, the AC-to-DC controller 430 also obtains the feedback voltage V_{FB1}, and the DC-to-DC controller 440 also obtains the feedback voltage V_{FB2}. For example, the feedback voltage V_{FB1} is generated based at least in part on the output voltage 351 at the USB output port 350. As an example, the feedback voltage V_{FB2} is generated based at least in part on the output voltage 353 at the USB output port 352. In certain examples, when the switch 340 is closed, the switch 342 is open, the switch 344 is open and the switch 346 is closed, the AC-to-DC converter 310 generates the output voltage 351 at the USB output port 350 based at least in part on the reference voltage V_{REF1}, the reference current I_{REF1}, the feedback current I_{FB1} and the feedback voltage V_{FB1}, and the DC-to-DC converter that includes the switch controller 380, the inductive coil 370 and the capacitor 360 generates the output voltage 353 at the USB output port 352 based at least in part on the reference voltage V_{REF2}, the reference current I_{REF2}, the feedback current I_{FB2} and the feedback voltage V_{FB2}. For example, the output voltage 351 is provided to charge a load (e.g., a mobile electronic device) at the USB output port 350 (e.g., a USB Type-C output port or a USB Type-A output port). As an example, the output voltage 353 is provided to charge a load (e.g., a mobile electronic device) at the USB output port 352 (e.g., a USB Type-C output port or a USB Type-A output port).

According to some embodiments, if the switch 340 is open, the switch 342 is closed, the switch 344 is closed, and the switch 346 is open, the voltage 311 (e.g., VIN) is used as the output voltage 353 to charge a load at the USB output port 352, and the voltage 331 is used as the output voltage 351 to charge a load at the USB output port 350. In some examples, when the switch 340 is open, the switch 342 is closed, the switch 344 is closed, and the switch 346 is open, the AC-to-DC controller 430 receives the reference voltage V_{REF2} and a voltage that represents the reference current I_{REF2}, and the DC-to-DC controller 440 receives the reference voltage V_{REF1} and a voltage that represents the reference current I_{REF1}. For example, the reference voltage V_{REF2} and the reference current I_{REF2} are generated based at least in part on the detected load demand information (e.g., Load Demand 2) for the USB output port 352. As an example, the reference voltage V_{REF1} and the reference current I_{REF1} are generated based at least in part on the detected load demand information (e.g., Load Demand 1) for the USB output port 350. In certain examples, when the switch 340 is open, the switch 342 is closed, the switch 344 is closed, and the switch 346 is open, the AC-to-DC controller 430 also receives a voltage that represents the feedback current I_{FB2}, and the DC-to-DC controller 440 also receives a voltage that represents the feedback current I_{FB1}. For example, the feedback current I_{FB2} is generated based at least in part on the output current 357 at the USB output port 352. As an example, the feedback current I_{FB1} is generated based at least in part on the output current 355 at the USB output port 350. In certain examples, when the switch 340 is open, the switch 342 is closed, the switch 344 is closed, and the switch 346 is open, the AC-to-DC controller 430 also obtains the feedback voltage V_{FB2}, and the DC-to-DC controller 440 also obtains the feedback voltage V_{FB1}. For example, the feedback voltage V_{FB2} is generated based at least in part on the output voltage 353 at the USB output port 352. As an example, the feedback voltage V_{FB1} is generated based at least in part on the output voltage 351 at the USB output port 350. In some examples, when the switch 340 is open, the switch 342 is closed, the switch 344 is closed, and the switch 346 is open, the AC-to-DC converter 310 generates the output voltage 353 at the USB output port 352 (e.g., a USB Type-C output port or a USB Type-A output port) based at least in part on the reference voltage V_{REF2}, the reference current I_{REF2}, the feedback current I_{FB2} and the feedback voltage V_{FB2}, and the DC-to-DC converter that includes the switch controller 380, the inductive coil 370 and the capacitor 360 generates the output voltage 351 at the USB output port 350 (e.g., a USB Type-C output port or a USB Type-A output port) based at least in part on the reference voltage V_{REF1}, the reference current I_{REF1}, the feedback current I_{FB1} and the feedback voltage V_{FB1}. For example, the output voltage 353 is provided to charge a load (e.g., a mobile electronic device) at the USB output port 352 (e.g., a USB Type-C output port or a USB Type-A output port). As an example, the output voltage 351 is provided to charge a load (e.g., a mobile electronic device) at the USB output port 350 (e.g., a USB Type-C output port or a USB Type-A output port).

As shown in FIG. 4, the load demand detector 410 generates a control signal 411 and outputs the control signal 411 to the load current sampling unit 420 according to certain embodiments. In some examples, the load current sampling unit 420 receives the control signal 411. In certain examples, the load current sampling unit 420 is coupled to the USB output port 350 and the USB output port 352. For example, the load current sampling unit 420, in response to the control signal 411, outputs a voltage that represents the feedback current I_{FB1} to the AC-to-DC controller 430. As an example, the load current sampling unit 420, in response to the control signal 411, outputs a voltage that represents the feedback current I_{FB1} to the DC-to-DC controller 440. For example, the load current sampling unit 420, in response to the control signal 411, outputs a voltage that represents the feedback current I_{FB2} to the AC-to-DC controller 430. As an example, the load current sampling unit 420, in response to the control signal 411, outputs a voltage that represents the feedback current I_{FB2} to the DC-to-DC controller 440. In some examples, the load current sampling unit 420 is implemented using one or more software components, one or more hardware components, and/or one or more combinations of software and hardware components

According to some embodiments, the load demand detector 410 generates the control signals 341, 343, 345 and 347 based at least in part on the detected load demand information (e.g., Load Demand 1) for the USB output port 350 and/or the detected load demand information (e.g., Load Demand 2) for the USB output port 352, and outputs the control signals 341, 343, 345 and 347 to the switches 340, 342, 344 and 346 respectively. In certain examples, the detected load demand information (e.g., Load Demand 1) for the USB output port 350 includes a detected load demand voltage for the USB output port 350. In some examples, the detected load demand information (e.g., Load Demand 2) for the USB output port 352 includes a detected load demand voltage for the USB output port 352. For example, if the control signal 341 is at a logic high level, the switch 340 is closed, and if the control signal 341 is at a logic low level, the switch 340 is open. As an example, if the control signal 343 is at a logic high level, the switch 342 is closed, and if the control signal 343 is at a logic low level, the switch 342 is open. For example, if the control signal 345 is at a logic high level, the switch 344 is closed, and if the control signal 345 is at a logic low level, the switch 344 is open. As an example, if the control signal 347 is at a logic high level, the switch 346 is closed, and if the control signal 347 is at a logic low level, the switch 346 is open. In certain examples, if the switch 340 is closed and the switch 342 is open, the USB output port 350 receives the voltage 311 (e.g., VIN) as the output voltage 351, and if the switch 340 is open and the switch 342 is closed, the USB output port 350 receives the voltage 331 as the output voltage 351. In some examples, if the switch 344 is closed and the switch 346 is open, the USB output port 352 receives the voltage 311 (e.g., VIN) as the output voltage 353, and if the switch 344 is open and the switch 346 is closed, the USB output port 352 receives the voltage 331 as the output voltage 353.

According to certain embodiments, the load demand detector 410 generates the control signals 341, 343, 345 and 347 and uses the control signals 341, 343, 345 and 347 to close and/or open the switches 340, 342, 344 and 346 respectively. For example, if a load (e.g., a mobile electronic device) is detected at the USB output port 350, one switch of the switch 340 and the switch 342 is closed, and the other switch of the switch 340 and the switch 342 is open. As an example, if no load is detected at the USB output port 350, both of the switch 340 and the switch 342 are open. For example, if a load (e.g., a mobile electronic device) is detected at the USB output port 352, one switch of the switch 344 and the switch 346 is closed, and the other switch of the switch 344 and the switch 346 is open. As an example, if no load is detected at the USB output port 352, both of the switch 344 and the switch 346 are open. In certain examples, if both of the switches 342 and 346 are open, the DC-to-DC controller 440 is in a sleep state.

In some embodiments, if no load is detected at the USB output port 350 and no load is detected at the USB output port 352, all of the switches 340, 342, 344, and 346 are open. Afterwards, if a load becomes detected at the USB output port 350 and no load is detected at the USB output port 352, the switch 340 becomes closed and the switches 342, 344, and 346 remain open, so that the voltage 311 (e.g., VIN) is used as the output voltage 351 to charge the load at the USB output port 350 according to certain embodiments. For example, if a load becomes detected at the USB output port 350 and no load is detected at the USB output port 352, the AC-to-DC controller 430 receives the reference voltage V_{REF1}, a voltage that represents the reference current I_{REF1}, and a voltage that represents the feedback current I_{FB1}, obtains the feedback voltage V_{FB1}, and generates the control signal 321 based on at least information associated with the reference voltage V_{REF1}, the reference current I_{REF1}, the feedback current I_{FB1} and the feedback voltage V_{FB1}, and the AC-to-DC converter 310 generates the voltage 311 (e.g., VIN), which is used as the output voltage 351 at the USB output port 350, based on at least information associated with the reference voltage V_{REF1}, the reference current I_{REF1}, the feedback current I_{FB1} and the feedback voltage V_{FB1}.

According to some embodiments, if a load is detected at the USB output port 350 and no load is detected at the USB output port 352, the switch 340 is closed and the switches 342, 344, and 346 are open, so that the voltage 311 (e.g., VIN) is used as the output voltage 351 to charge the load at the USB output port 350. For example, if a load is detected at the USB output port 350 and no load is detected at the USB output port 352, the AC-to-DC controller 430 receives the reference voltage V_{REF1}, a voltage that represents the reference current I_{REF1}, and a voltage that represents the feedback current I_{FB1}, obtains the feedback voltage V_{FB1}, and generates the control signal 321 based on at least information associated with the reference voltage V_{REF1}, the reference current I_{REF1}, the feedback current I_{FB1} and the feedback voltage V_{FB1}, and the AC-to-DC converter 310 generates the voltage 311 (e.g., VIN), which is used as the output voltage 351 at the USB output port 350, based on at least information associated with the reference voltage V_{REF1}, the reference current I_{REF1}, the feedback current I_{FB1} and the feedback voltage V_{FB1}. As an example, if a load is detected at the USB output port 350 and no load is detected at the USB output port 352, the switch controller 380 is disabled by the signal 387.

In certain embodiments, when a load (e.g., a mobile electronic device) is being charged at the USB output port 350, if another load (e.g., a mobile electronic device) becomes detected at the USB output port 352, the load demand detector 410 compares a detected load demand voltage for the USB output port 350 and a detected load demand voltage for the USB output port 352 by comparing the reference voltage V_{REF1} and the reference voltage V_{REF2}.

According to some embodiments, when a load (e.g., a mobile electronic device) is being charged at the USB output port 350, if another load (e.g., a mobile electronic device) becomes detected at the USB output port 352 and if the reference voltage V_{REF2} is smaller than or equal to the reference voltage V_{REF1}, the DC-to-DC controller 440 receives the reference voltage V_{REF2}, a voltage that represents the reference current I_{REF2}, and a voltage that represents the feedback current I_{FB2}, obtains the feedback voltage V_{FB2}, and generates the signal 389 based on at least information associated with the reference voltage V_{REF2}, the reference current I_{REF2}, the feedback current I_{FB2} and the feedback voltage V_{FB2}, and the DC-to-DC converter, which includes the capacitor 360, the inductive coil 370, and the switch controller 380, generates the voltage 331 based on at least information associated with the reference voltage V_{REF2}, the reference current I_{REF2}, the feedback current I_{FB2} and the feedback voltage V_{FB2}, wherein the voltage 331 is used as the output voltage 353 at the USB output port 352. For example, when a load (e.g., a mobile electronic device) is being charged at the USB output port 350, if another load (e.g., a mobile electronic device) becomes detected at the USB output port 352 and if the reference voltage V_{REF2} is smaller than or equal to the reference voltage V_{REF1}, the AC-to-DC controller 430 receives the reference voltage V_{REF1}, a voltage that represents the reference current I_{REF1}, and a voltage that represents the feedback current I_{FB1}, obtains the feedback voltage V_{FB1}, and generates the control signal 321 based on at least information associated with the reference voltage V_{REF1}, the reference current I_{REF1}, the feedback current I_{FB1} and the feedback voltage V_{FB1}, and the AC-to-DC converter 310 generates the voltage 311 (e.g., VIN), which is used as the output voltage 351 at the USB output port 350, based on at least information associated with the reference voltage V_{REF1}, the reference current I_{REF1}, the feedback current I_{FB1} and the feedback voltage V_{FB1}.

According to certain embodiments, when a load (e.g., a mobile electronic device) is being charged at the USB output port 350, if another load (e.g., a mobile electronic device) becomes detected at the USB output port 352 and if the reference voltage V_{REF2} is larger than the reference voltage V_{REF1}, the switch controller 380 is enabled by the signal 387. For example, when a load (e.g., a mobile electronic device) is being charged at the USB output port 350, if another load (e.g., a mobile electronic device) becomes detected at the USB output port 352 and if the reference voltage V_{REF2} is larger than the reference voltage V_{REF1}, initially, the switch 340 remains closed, the switches 342 and 344 remain open, and the switch 346 becomes closed, so that the voltage 311 (e.g., VIN) is used as the output voltage 351 to charge the load at the USB output port 350 and the voltage 331 is used as the output voltage 353 at the USB output port 352. As an example, when a load (e.g., a mobile electronic device) is being charged at the USB output port 350, if another load (e.g., a mobile electronic device) becomes detected at the USB output port 352 and if the reference voltage V_{REF2} is larger than the reference voltage V_{REF1}, initially, the AC-to-DC controller 430 receives the reference voltage V_{REF1}, a voltage that represents the reference current I_{REF1}, and a voltage that represents the feedback current I_{FB1}, obtains the feedback voltage V_{FB1}, and generates the control signal 321 based on at least information associated with the reference voltage V_{REF1}, the reference current I_{REF1}, the feedback current I_{FB1} and the feedback voltage V_{FB1}, and the AC-to-DC converter 310 generates the voltage 311 (e.g., VIN), which is used as the output voltage 351 at the USB output port 350, based on at least information associated with the reference voltage V_{REF1}, the reference current I_{REF1}, the feedback current I_{FB1} and the feedback voltage V_{FB1}. For example, when a load (e.g., a mobile electronic device) is being charged at the USB output port 350, if another load (e.g., a mobile electronic device) becomes detected at the USB output port 352 and if the reference voltage V_{REF2} is larger than the reference voltage V_{REF1}, initially, the DC-to-DC controller 440 receives the reference voltage V_{REF1}, a voltage that represents the reference current I_{REF2}, and a voltage that represents the feedback current I_{FB2}, obtains the feedback voltage V_{FB2}, and generates the signal 389 based on at least information associated with the reference voltage V_{REF1}, the reference current I_{REF2}, the feedback current I_{FB2} and the feedback voltage V_{FB2}, and the DC-to-DC converter, which includes the capacitor 360, the inductive coil 370, and the switch controller 380, generates the voltage 331 based on at least information associated with the reference voltage V_{REF1}, the reference current I_{REF2}, the feedback current I_{FB2} and the feedback voltage V_{FB2}, wherein the voltage 331 is used as the output voltage 353 at the USB output port 352. In certain examples, initially, based on at least information associated with the reference voltage V_{REF1}, the reference current I_{REF1}, the feedback current I_{FB1} and the feedback voltage V_{FB1}, the AC-to-DC converter 310 keeps the voltage 311 (e.g., VIN) constant with time, wherein the voltage 311 (e.g., VIN) remains being used as the output voltage 351 at the USB output port 350. In some examples, initially, based on at least information associated with the reference voltage V_{REF1}, the reference current I_{REF2}, the feedback current I_{FB2} and the feedback voltage V_{FB2}, the DC-to-DC converter, which includes the capacitor 360, the inductive coil 370, and the switch controller 380, increases the voltage 331 with time, wherein the voltage 331 remains being used as the output voltage 353 at the USB output port 352.

Afterwards, when the voltage 331 becomes equal to the detected load demand voltage for the USB output port 350 (e.g., when the feedback voltage V_{FB2} becomes equal to the reference voltage V_{REF1}), the switch 340 becomes open, the switch 342 becomes closed, the switch 344 becomes closed, and the switch 346 becomes open, so that the voltage 311 (e.g., VIN) becomes being used as the output voltage 353 to charge the load at the USB output port 352 and the voltage 331 becomes being used as the output voltage 351 to charge the load at the USB output port 350, according to some embodiments. For example, afterwards, when the voltage 331 becomes equal to the detected load demand voltage for the USB output port 350 (e.g., when the feedback voltage V_{FB2} becomes equal to the reference voltage V_{REF1}), the DC-to-DC controller 440 remains receiving the reference voltage V_{REF1}, becomes receiving a voltage that represents the reference current I_{REF1} and a voltage that represents the feedback current I_{FB1}, becomes obtaining the feedback voltage V_{FB1}, and generates the signal 389 based on at least information associated with the reference voltage V_{REF1}, the reference current I_{REF1}, the feedback current I_{FB1} and the feedback voltage V_{FB1}, and the DC-to-DC converter, which includes the capacitor 360, the inductive coil 370, and the switch controller 380, generates the voltage 331 based on at least information associated with the reference voltage V_{REF1}, the reference current I_{REF1}, the feedback current I_{FB1} and the feedback voltage V_{FB1}, wherein the voltage 331 becomes being used as the output voltage 351 at the USB output port 350. As an example, afterwards, when the voltage 331 becomes equal to the detected load demand voltage for the USB output port 350 (e.g., when the feedback voltage V_{FB2} becomes equal to the reference voltage V_{REF1}), the AC-to-DC controller 430 becomes receiving the reference voltage V_{REF2}, a voltage that represents the reference current I_{REF2}, and a voltage that represents the feedback current I_{FB2}, becomes obtaining the feedback voltage V_{FB2}, and generates the control signal 321 based on at least information associated with the reference voltage V_{REF2}, the reference current I_{REF2}, the feedback current I_{FB2} and the feedback voltage V_{FB2}, and the AC-to-DC converter 310 generates the voltage 311 (e.g., VIN), which is used as the output voltage 353 at the USB output port 352, based on at least information associated with the reference voltage V_{REF2}, the reference current I_{REF2}, the feedback current I_{FB2} and the feedback voltage V_{FB2}.

Then, the switch 340 remains open, the switch 342 remains closed, the switch 344 remains closed, and the switch 346 remains open, so that the voltage 311 (e.g., VIN) remains being used as the output voltage 353 to charge the load at the USB output port 352 and the voltage 331 remains being used as the output voltage 351 to charge the load at the USB output port 350, according to certain embodiments. For example, then, the DC-to-DC controller 440 remains receiving the reference voltage V_{REF1}, receiving a voltage that represents the reference current I_{REF1}, receiving a voltage that represents the feedback current I_{FB1}, and obtaining the feedback voltage V_{FB1}, and generates the signal 389 based on at least information associated with the reference voltage V_{REF1}, the reference current I_{REF1}, the feedback current I_{FB1} and the feedback voltage V_{FB1}, and the DC-to-DC converter, which includes the capacitor 360, the inductive coil 370, and the switch controller 380, generates the voltage 331 based on at least information associated with the reference voltage V_{REF1}, the reference current I_{REF1}, the feedback current I_{FB1} and the feedback voltage V_{FB1}, wherein the voltage 331 remains being used as the output voltage 351 at the USB output port 350. As an example, then, the AC-to-DC controller 430 remains receiving the reference voltage V_{REF2}, receiving a voltage that represents the reference current I_{REF2}, receiving a voltage that represents the feedback current I_{FB2}, and obtaining the feedback voltage V_{FB2}, and generates the control signal 321 based on at least information associated with the reference voltage V_{REF2}, the reference current I_{REF2}, the feedback current I_{FB2} and the feedback voltage V_{FB2}, and the AC-to-DC converter 310 generates the voltage 311 (e.g., VIN), which remains being used as the output voltage 353 at the USB output port 352, based on at least information associated with the reference voltage V_{REF2}, the reference current I_{REF2}, the feedback current I_{FB2} and the feedback voltage V_{FB2}. In some examples, then, based on at least information associated with the reference voltage V_{REF1}, the reference current I_{REF1}, the feedback current I_{FB1} and the feedback voltage V_{FB1}, the DC-to-DC converter, which includes the capacitor 360, the inductive coil 370, and the switch controller 380, keeps the voltage 331 constant with time, wherein the voltage 331 remains being used as the output voltage 351 at the USB output port 350. In certain examples, then, based on at least information associated with the reference voltage V_{REF2}, the reference current I_{REF2}, the feedback current I_{FB2} and the feedback voltage V_{FB2}, the AC-to-DC converter 310 increases the voltage 311 (e.g., VIN) with time until the voltage 311 (e.g., VIN) becomes equal to the detected load demand voltage for the USB output port 352 (e.g., until the feedback voltage V_{FB2} becomes equal to the reference voltage V_{REF2}), wherein the voltage 311 (e.g., VIN) remains being used as the output voltage 353 at the USB output port 352. In some examples, then, based on at least information associated with the reference voltage V_{REF2}, the reference current I_{REF2}, the feedback current I_{FB2} and the feedback voltage V_{FB2}, the AC-to-DC converter 310 increases the voltage 311 (e.g., VIN) until the voltage 311 (e.g., VIN) becomes equal to the detected load demand voltage for the USB output port 352 (e.g., until the feedback voltage V_{FB2} becomes equal to the reference voltage V_{REF2}).

In some embodiments, if a load (e.g., a mobile electronic device) is detected at the USB output port 350 and no load is detected at the USB output port 352, the load at the USB output port 350 is charged by the voltage 311 (e.g., VIN) generated by the AC-to-DC converter 310. For example, if a load (e.g., a mobile electronic device) is detected at the USB output port 350 and no load is detected at the USB output port 352, the switch 340 is closed and the switches 342, 344 and 346 are open, in order to use the voltage 311 (e.g., VIN) to charge the load at the USB output port 350.

In certain embodiments, when the load (e.g., a mobile electronic device) is being charged at the USB output port 350 (e.g., when the switch 340 is closed and the switches 342, 344 and 346 are open), if another load becomes being detected at the USB output port 352, the load demand detector 410 compares a detected load demand voltage for the USB output port 350 and a detected load demand voltage for the USB output port 352 by comparing the reference voltage V_{REF1} and the reference voltage V_{REF2}.

According to some embodiments, if the comparison shows that the reference voltage V_{REF2} is smaller than or equal to the reference voltage V_{REF1}, the switch 340 remains closed, the switches 342 and 344 remain open, and the switch 346 becomes closed. In some examples, the reference voltage V_{REF1}, a voltage that represents the reference current I_{REF1}, and a voltage that represents the feedback current I_{FB1} remain being received by the AC-to-DC controller 430, the feedback voltage V_{FB1} remains being obtained by the AC-to-DC controller 430, and the output voltage 351 at the USB output port 350 remains being generated by the AC-to-DC converter 310 based on at least information associated with the reference voltage V_{REF1}, the reference current I_{REF1}, the feedback current I_{FB1} and the feedback voltage V_{FB1}. In certain examples, the reference voltage V_{REF2}, a voltage that represents the reference current I_{REF2}, and a voltage that represents the feedback current I_{FB2} become being received by the DC-to-DC controller 440, the feedback voltage V_{FB2} becomes being obtained by the DC-to-DC controller 440, and the output voltage 353 at the USB output port 352 becomes being generated by the DC-to-DC converter that includes the switch controller 380, the inductive coil 370 and the capacitor 360 based on at least information associated with the reference voltage V_{REF2}, the reference current I_{REF2}, the feedback current I_{FB2} and the feedback voltage V_{FB2}. For example, the switch controller 380 is enabled by the signal 387.

According to certain embodiments, if the comparison shows that the reference voltage V_{REF2} is larger than the reference voltage V_{REF1}, initially the switch 340 remains closed, the switches 342 and 344 remain open, and the switch 346 becomes closed. In certain examples, initially, the reference voltage V_{REF1}, a voltage that represents the reference current I_{REF1}, and a voltage that represents the feedback current I_{FB1} also remain being received by the AC-to-DC controller 430, the feedback voltage V_{FB1} also remains being obtained by the AC-to-DC controller 430, and the output voltage 351 at the USB output port 350 also remains being generated by the AC-to-DC converter 310 based on at least information associated with the reference voltage V_{REF1}, the reference current I_{REF1}, the feedback current I_{FB1} and the feedback voltage V_{FB1}. In some examples, initially, the reference voltage V_{REF1}, a voltage that represents the reference current I_{REF2}, and a voltage that represents the feedback current I_{FB2} become also being received by the DC-to-DC controller 440, the feedback voltage V_{FB2} becomes being obtained by the DC-to-DC controller 440, and the output voltage 353 at the USB output port 352 becomes being generated by the DC-to-DC converter that includes the switch controller 380, the inductive coil 370 and the capacitor 360 based on at least information associated with the reference voltage V_{REF1}, the reference current I_{REF2}, the feedback current I_{FB2} and the feedback voltage V_{FB2}. Afterwards, in certain examples, when the voltage 331, which is generated by the DC-to-DC converter that includes the switch controller 380, the inductive coil 370 and the capacitor 360, becomes equal to the detected load demand voltage for the USB output port 350, the switch 342 becomes closed, the switch 340 becomes open, the switch 344 becomes closed, and the switch 346 becomes open. For example, the voltage 331 becomes being used as the output voltage 351 at the USB output port 350, and the voltage 311 (e.g., VIN) becomes being used as the output voltage 353 at the USB output port 352. As an example, the reference voltage V_{REF2}, a voltage that represents the reference current I_{REF2}, and a voltage that represents the feedback current I_{FB2} become being received by the AC-to-DC controller 430, the feedback voltage V_{FB2} becomes being obtained by the AC-to-DC controller 430, and based on at least information associated with the reference voltage V_{REF2}, the reference current I_{REF2}, the feedback current I_{FB2}, and the feedback voltage V_{FB2}, the AC-to-DC converter 310 increases the voltage 311 (e.g., VIN) until the voltage 311 (e.g., VIN), which is used as the output voltage 353 at the USB output port 352, becomes equal to the detected load demand voltage for the USB output port 352.

In some embodiments, the switch 340 is closed, the switches 342 and 344 are open, and the switch 346 is closed, so that a load (e.g., a mobile electronic device) at the USB output port 350 is being charged by the voltage 311 (e.g., VIN) and another load (e.g., a mobile electronic device) at the USB output port 352 is being charged by the voltage 331, wherein initially, the voltage 311 (e.g., VIN) is equal to the detected load demand voltage for the USB output port 350, the voltage 331 is equal to the detected load demand voltage for the USB output port 352, and the detected load demand voltage for the USB output port 352 is smaller than the detected load demand voltage for the USB output port 350.

Afterwards, in certain examples, when the reference voltage V_{REF2} becomes larger than the reference voltage V_{REF1}, the switch 340 remains closed, the switches 342 and 344 remain open, and the switch 346 remains closed, so that a load (e.g., a mobile electronic device) at the USB output port 350 remains being charged by the voltage 311 (e.g., VIN) and another load (e.g., a mobile electronic device) at the USB output port 352 remains being charged by the voltage 331. For example, immediately after the reference voltage V_{REF2} becomes larger than the reference voltage V_{REF1}, the reference voltage V_{REF1}, a voltage that represents the reference current I_{REF1}, and a voltage that represents the feedback current I_{FB1} remain being received by the AC-to-DC controller 430, the feedback voltage V_{FB1} remains being obtained by the AC-to-DC controller 430, and the output voltage 351 at the USB output port 350 remains being generated by the AC-to-DC converter 310 based on at least information associated with the reference voltage V_{REF1}, the reference current I_{REF1}, the feedback current I_{FB1} and the feedback voltage V_{FB1}. As an example, immediately after the reference voltage V_{REF2} becomes larger than the reference voltage V_{REF1}, the reference voltage V_{REF1} becomes being received by the DC-to-DC controller 440, a voltage that represents the reference current I_{REF2} and a voltage that represents the feedback current I_{FB2} remain being received by the DC-to-DC controller 440, and the feedback voltage V_{FB2} remains being obtained by the DC-to-DC controller 440, so that the voltage 331, which is generated by the DC-to-DC converter that includes the switch controller 380, the inductive coil 370 and the capacitor 360, starts increasing with time, when the voltage 331 remains being used as the output voltage 353 at the USB output port 352.

Later, in some examples, when the voltage 331 reaches the detected load demand voltage for the USB output port 350, the switch 340 becomes open, the switch 342 becomes closed, the switch 344 becomes closed, and the switch 346 becomes open, so that a load (e.g., a mobile electronic device) at the USB output port 350 becomes being charged by the voltage 331 and another load (e.g., a mobile electronic device) at the USB output port 352 becomes being charged by the voltage 311 (e.g., VIN). For example, when the voltage 331 reaches the detected load demand voltage for the USB output port 350, the voltage 331 becomes being used as the output voltage 351 at the USB output port 350, and the voltage 311 (e.g., VIN) becomes being used as the output voltage 353 at the USB output port 352. As an example, when the voltage 331 reaches the detected load demand voltage for the USB output port 350, the reference voltage V_{REF2}, a voltage that represents the reference current I_{REF2}, and a voltage that represents the feedback current I_{FB2} become being received by the AC-to-DC controller 430, the feedback voltage V_{FB2} becomes being obtained by the AC-to-DC controller 430, and based on at least information associated with the reference voltage V_{REF2}, the reference current I_{REF2}, the feedback current I_{FB2} and the feedback voltage V_{FB2}, the AC-to-DC converter 310 increases the voltage 311 (e.g., VIN) until the voltage 311 (e.g., VIN), which is used as the output voltage 353 at the USB output port 352, becomes equal to the detected load demand voltage for the USB output port 352.

According to certain embodiments, the AC-to-DC converter 310 converts the voltage 309 (e.g., an input voltage) to the voltage 311 (e.g., VIN) based on at least information associated with the control signal 321. For example, the control signal 321 is generated based on at least information associated with the reference voltage V_{REF1}, the reference current I_{REF1}, the feedback current I_{FB1} and the feedback voltage V_{FB1}, and the AC-to-DC converter 310 generates the voltage 311 (e.g., VIN) based on at least information associated with the control signal 321. As an example, the control signal 321 is generated based on at least information associated with the reference voltage V_{REF2}, the reference current I_{REF2}, the feedback current I_{FB2} and the feedback voltage V_{FB2}, and the AC-to-DC converter 310 generates the voltage 311 (e.g., VIN) based on at least information associated with the control signal 321.

According to some embodiments, the DC-to-DC converter, which includes the capacitor 360, the inductive coil 370, and the switch controller 380, converts the voltage 311 (e.g., VIN) to the voltage 331 based on at least information associated with the signal 389. For example, the signal 389 is generated based on at least information associated with the reference voltage V_{REF2}, the reference current I_{REF2}, the feedback current I_{FB2} and the feedback voltage V_{FB2}, and the DC-to-DC converter, which includes the capacitor 360, the inductive coil 370, and the switch controller 380, generates the voltage 331 based on at least information associated with the signal 389. As an example, the signal 389 is generated based on at least information associated with the reference voltage V_{REF1}, the reference current I_{REF2}, the feedback current I_{FB2} and the feedback voltage V_{FB2}, and the DC-to-DC converter, which includes the capacitor 360, the inductive coil 370, and the switch controller 380, generates the voltage 331 based on at least information associated with the signal 389. For example, the signal 389 is generated based on at least information associated with the reference voltage V_{REF1}, the reference current I_{REF1}, the feedback current I_{FB1} and the feedback voltage V_{FB1}, and the DC-to-DC converter, which includes the capacitor 360, the inductive coil 370, and the switch controller 380, generates the voltage 331 based on at least information associated with the signal 389.

As discussed above and further emphasized here, FIG. 4 is merely an example, which should not unduly limit the scope of the claims. One of ordinary skill in the art would recognize many variations, alternatives, and modifications. In some embodiments, the error amplifier 454 receives a voltage that represents a feedback current (e.g., I_{FB1} or I_{FB2}) from the load current sampling unit 420 and also receives a voltage that represents a reference current (e.g., I_{REF1} or I_{REF2}) from the load demand detector 410, and/or the error amplifier 474 receives a voltage that represents a feedback current (e.g., I_{FB1} or I_{FB2}) from the load current sampling unit 420 and also receives a voltage that represents a reference current (e.g., I_{REF1} or I_{REF2}) from the load demand detector 410.

In certain embodiments, the error amplifier 454 receives a feedback current (e.g., I_{FB1} or I_{FB2}) from the load current sampling unit 420 and also receives a reference current (e.g., I_{REF1} or I_{REF2}) from the load demand detector 410, and/or the error amplifier 474 receives a feedback current (e.g., I_{FB1} or I_{FB2}) from the load current sampling unit 420 and also receives a reference current (e.g., I_{REF1} or I_{REF2}) from the load demand detector 410. For example, the error amplifier 454 converts the received feedback current (e.g., I_{FB1} or I_{FB2}) to a voltage that represents the received feedback current (e.g., I_{FB1} or I_{FB2}), and also converts the received reference current (e.g., I_{REF1} or I_{REF2}) to a voltage that represents the received reference current (e.g., I_{REF1} or I_{REF2}). As an example, the error amplifier 474 converts the received feedback current (e.g., I_{FB1} or I_{FB2}) to a voltage that represents the received feedback current (e.g., I_{FB1} or I_{FB2}), and also converts the received reference current (e.g., I_{REF1} or I_{REF2}) to a voltage that represents the received reference current (e.g., I_{REF1} or I_{REF2}).

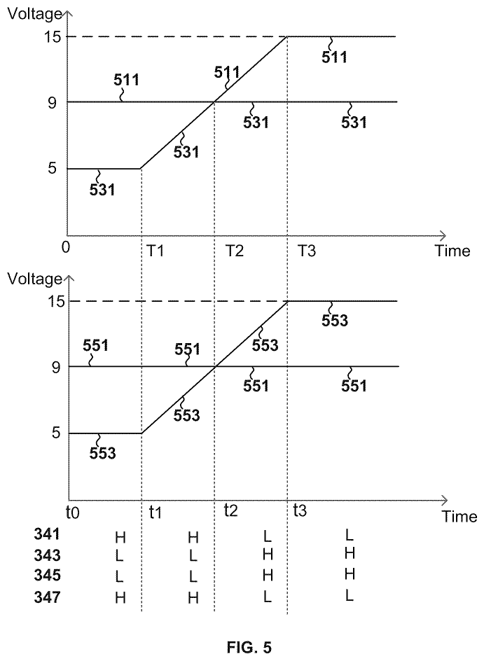

FIG. 5 shows simplified timing diagrams for the USB charging system 300 as shown in FIG. 3 and FIG. 4 according to certain embodiments of the present disclosure. These diagrams are merely examples, which should not unduly limit the scope of the claims. One of ordinary skill in the art would recognize many variations, alternatives, and modifications. The waveform 511 represents the voltage 311 (e.g., VIN) as a function of time, the waveform 531 represents the voltage 331 as a function of time, the waveform 551 represents the output voltage 351 as a function of time, and the waveform 553 represents the output voltage 353 as a function of time.

In some embodiments, at time t₀, the control signal 341 is at the logic high level, the control signal 343 is at the logic low level, the control signal 345 is at the logic low level, and the control signal 347 is at the logic high level. For example, at time t₀, the switch 340 is closed, the switch 342 is open, the switch 344 is open, and the switch 346 is closed. In certain examples, from time t₀ to time t₁, the control signal 341 remains at the logic high level, the control signal 343 remains at the logic low level, the control signal 345 remains at the logic low level, and the control signal 347 remains at the logic high level. For example, from time t₀ to time t₁, the switch 340 remains closed, the switch 342 remains open, the switch 344 remains open, and the switch 346 remains closed. In some examples, at time t₁, the control signal 341 remains at the logic high level, the control signal 343 remains at the logic low level, the control signal 345 remains at the logic low level, and the control signal 347 remains at the logic high level. For example, from time t₁, the switch 340 remains closed, the switch 342 remains open, the switch 344 remains open, and the switch 346 remains closed. In certain examples, from time t₁ to time t₂, the control signal 341 remains at the logic high level, the control signal 343 remains at the logic low level, the control signal 345 remains at the logic low level, and the control signal 347 remains at the logic high level. For example, from time t₁ to time t₂, the switch 340 remains closed, the switch 342 remains open, the switch 344 remains open, and the switch 346 remains closed.

In certain embodiments, at time t₂, the control signal 341 changes from the logic high level to the logic low level, the control signal 343 changes from the logic low level to the logic high level, the control signal 345 changes from the logic low level to the logic high level, and the control signal 347 changes from the logic high level to the logic low level. For example, at time t₂, the switch 340 becomes open, the switch 342 becomes closed, the switch 344 becomes closed, and the switch 346 becomes open. In some examples, from time t₂ to time t₃, the control signal 341 remains at the logic low level, the control signal 343 remains at the logic high level, the control signal 345 remains at the logic high level, and the control signal 347 remains at the logic low level. For example, from time t₂ to time t₃, the switch 340 remains open, the switch 342 remains closed, the switch 344 remains closed, and the switch 346 remains open. In certain examples, at time t₃, the control signal 341 remains at the logic low level, the control signal 343 remains at the logic high level, the control signal 345 remains at the logic high level, and the control signal 347 remains at the logic low level. For example, at time t₃, the switch 340 remains open, the switch 342 remains closed, the switch 344 remains closed, and the switch 346 remains open. In some examples, after time t₃, the control signal 341 remains at the logic low level, the control signal 343 remains at the logic high level, the control signal 345 remains at the logic high level, and the control signal 347 remains at the logic low level. For example, after time t₃, the switch 340 remains open, the switch 342 remains closed, the switch 344 remains closed, and the switch 346 remains open.

According to certain embodiments, the control signal 341 is used to close (e.g., turn on) and/or open (e.g., turn off) the switch 340 (e.g., a transistor), the control signal 343 is used to close (e.g., turn on) and/or open (e.g., turn off) the switch 342 (e.g., a transistor), the control signal 345 is used to close (e.g., turn on) and/or open (e.g., turn off) the switch 344 (e.g., a transistor), and the control signal 347 is used to close (e.g., turn on) and/or open (e.g., turn off) the switch 346 (e.g., a transistor). In some examples, if the control signal 341 is at a logic high level, the switch 340 is closed (e.g., the transistor 340 is turned on), and if the control signal 341 is at a logic low level, the switch 340 is open (e.g., the transistor 340 is turned off). In certain examples, if the control signal 343 is at a logic high level, the switch 342 is closed (e.g., the transistor 342 is turned on), and if the control signal 343 is at a logic low level, the switch 342 is open (e.g., the transistor 342 is turned off). In some examples, if the control signal 345 is at a logic high level, the switch 344 is closed (e.g., the transistor 344 is turned on), and if the control signal 345 is at a logic low level, the switch 344 is open (e.g., the transistor 344 is turned off). In certain examples, if the control signal 347 is at a logic high level, the switch 346 is closed (e.g., the transistor 346 is turned on), and if the control signal 347 is at a logic low level, the switch 346 is open (e.g., the transistor 346 is turned off).

According to certain embodiments, at time t₂, the switch 340 (e.g., the transistor 340) changes from being closed (e.g., being turned on) to being open (e.g., being turned off), the switch 342 (e.g., the transistor 342) changes from being open (e.g., being turned off) to being closed (e.g., being turned on), the switch 344 (e.g., the transistor 344) changes from being open (e.g., being turned off) to being closed (e.g., being turned on), and the switch 346 (e.g., the transistor 346) changes from being closed (e.g., being turned on) to being open (e.g., being turned off). In some examples, from time t₀ to time t₂, the switch 340 remains closed (e.g., the transistor 340 remains turned on), the switch 342 remains open (e.g., the transistor 342 remains turned off), the switch 344 remains open (e.g., the transistor 344 remains turned off), and the switch 346 remains closed (e.g., the transistor 346 remains turned on). In certain examples, after time t₂ (e.g., including after time t₃), the switch 340 remains open (e.g., the transistor 340 remains turned off), the switch 342 remains closed (e.g., the transistor 342 remains turned on), the switch 344 remains closed (e.g., the transistor 344 remains turned on), and the switch 346 remains open (e.g., the transistor 346 remains turned off).

As shown in FIG. 5, at time t₀, the detected load demand voltage for the USB output port 350 is equal to 9 volts, and the detected load demand voltage for the USB output port 352 is equal to 5 volts, according to some embodiments. For example, at time t₀, the reference voltage V_{REF1} is equal to a voltage value Vₐ that corresponds to 9 volts of the detected load demand voltage for the USB output port 350, and the reference voltage V_{REF2} is equal to a voltage value V_{b} that corresponds to 5 volts of the detected load demand voltage for the USB output port 352. As an example, the voltage value Vₐ of the reference voltage V_{REF1} is larger than the voltage value V_{b} of the reference voltage V_{REF2}. In certain examples, from time t₀ to time t₁, the detected load demand voltage for the USB output port 350 is equal to 9 volts, and the detected load demand voltage for the USB output port 352 is equal to 5 volts. For example, from time t₀ to time t₁, the reference voltage V_{REF1} remains equal to the voltage value Vₐ that corresponds to 9 volts of the detected load demand voltage for the USB output port 350, and the reference voltage V_{REF2} remains equal to the voltage value V_{b} that corresponds to 5 volts of the detected load demand voltage for the USB output port 352. In some examples, at time t₁, the detected load demand voltage for the USB output port 350 remains equal to 9 volts, and the detected load demand voltage for the USB output port 352 changes from 5 volts to 15 volts. For example, at time t₁, the reference voltage V_{REF1} remains equal to the voltage value Vₐ that corresponds to 9 volts of the detected load demand voltage for the USB output port 350, and the reference voltage V_{REF2} changes from being equal to the voltage value V_{b} to being equal to a voltage value V_{c}, wherein the voltage value V_{c} corresponds to 15 volts of the detected load demand voltage for the USB output port 352. As an example, the voltage value Vₐ of the reference voltage V_{REF1} is smaller than the voltage value V_{c} of the reference voltage V_{REF2}. For example, at time t₁, the detected load demand current for the USB output port 352 changes its value, and the reference current I_{REF2}, which represents the detected load demand current for the USB output port 352, also changes. In certain examples, after time t₁ (e.g., including after time t₂, and/or including after time t₃), the detected load demand voltage for the USB output port 350 remains equal to 9 volts, and the detected load demand voltage for the USB output port 352 remains equal to 15 volts. For example, after time t₁, the reference voltage V_{REF1} remains equal to the voltage value Vₐ that corresponds to 9 volts of the detected load demand voltage for the USB output port 350, and the reference voltage V_{REF2} remains equal to the voltage value V_{c} that corresponds to 15 volts of the detected load demand voltage for the USB output port 352.

In some embodiments, at time t₀, the switch 340 is closed (e.g., the transistor 340 is turned on), the switch 342 is open (e.g., the transistor 342 is turned off), the switch 344 is open (e.g., the transistor 344 is turned off), and the switch 346 is closed (e.g., the transistor 346 is turned on), so that the voltage 311 is used as the output voltage 351 and the voltage 331 is used as the output voltage 353. For example, at time t₀, as shown by the waveforms 511 and 551, the voltage 311 is equal to 9 volts, and the output voltage 351 is also equal to 9 volts, which is the value of the detected load demand voltage for the USB output port 350 at time t₀. As an example, at time t₀, as shown by the waveforms 531 and 553, the voltage 331 is equal to 5 volts, and the output voltage 353 is also equal to 5 volts, which is the value of the detected load demand voltage for the USB output port 352 at time t₀. In certain examples, at time t₀, the AC-to-DC controller 430 receives the reference voltage V_{REF1}, a voltage that represents the reference current I_{REF1}, and a voltage that represents the feedback current I_{FB1}, obtains the feedback voltage V_{FB1}, and generates the control signal 321 based on at least information associated with the reference voltage V_{REF1}, the reference current I_{REF1}, the feedback current I_{FB1} and the feedback voltage V_{FB1}, and the AC-to-DC converter 310 generates the voltage 311 (e.g., VIN) based on at least information associated with the reference voltage V_{REF1}, the reference current I_{REF1}, the feedback current I_{FB1} and the feedback voltage V_{FB1}, wherein the voltage 311 is used as the output voltage 351 at the USB output port 350. For example, at time t₀, the voltage 311 is equal to 9 volts, which is the value of the detected load demand voltage for the USB output port 350. As an example, at time t₀, the feedback voltage V_{FB1} is equal to the voltage value Vₐ of the reference voltage V_{REF1}. In some examples, at time t₀, the DC-to-DC controller 440 receives the reference voltage V_{REF2}, a voltage that represents the reference current I_{REF2}, and a voltage that represents the feedback current I_{FB2}, obtains the feedback voltage V_{FB2}, and generates the signal 389 based on at least information associated with the reference voltage V_{REF2}, the reference current I_{REF2}, the feedback current I_{FB2} and the feedback voltage V_{FB2}, and the DC-to-DC converter, which includes the capacitor 360, the inductive coil 370, and the switch controller 380, generates the voltage 331 based on at least information associated with the reference voltage V_{REF2}, the reference current I_{REF2}, the feedback current I_{FB2} and the feedback voltage V_{FB2}, wherein the voltage 331 is used as the output voltage 353 at the USB output port 352. For example, at time t₀, the voltage 331 is equal to 5 volts, which is the value of the detected load demand voltage for the USB output port 352. As an example, at time t₀, the feedback voltage V_{FB2} is equal to the voltage value V_{b} of the reference voltage V_{REF2}.

In certain embodiments, from time t₀ to time t₁, the switch 340 is closed (e.g., the transistor 340 is turned on), the switch 342 is open (e.g., the transistor 342 is turned off), the switch 344 is open (e.g., the transistor 344 is turned off), and the switch 346 is closed (e.g., the transistor 346 is turned on), so that the voltage 311 is used as the output voltage 351 and the voltage 331 is used as the output voltage 353. For example, from time t₀ to time t₁, as shown by the waveforms 511 and 551, the voltage 311 is equal to 9 volts, and the output voltage 351 is also equal to 9 volts, which is the value of the detected load demand voltage for the USB output port 350 from time t₀ to time t₁. As an example, from time t₀ to time t₁, as shown by the waveforms 531 and 553, the voltage 331 is equal to 5 volts, and the output voltage 353 is also equal to 5 volts, which is the value of the detected load demand voltage for the USB output port 352 from time t₀ to time t₁. In some examples, from time t₀ to time t₁, the AC-to-DC controller 430 remains receiving the reference voltage V_{REF1}, a voltage that represents the reference current I_{REF1}, and a voltage that represents the feedback current I_{FB1}, remains obtaining the feedback voltage V_{FB1}, and generates the control signal 321 based on at least information associated with the reference voltage V_{REF1}, the reference current I_{REF1}, the feedback current I_{FB1} and the feedback voltage V_{FB1}, and the AC-to-DC converter 310 generates the voltage 311 (e.g., VIN) based on at least information associated with the reference voltage V_{REF1}, the reference current I_{REF1}, the feedback current I_{FB1} and the feedback voltage V_{FB1}, wherein the voltage 311 remains being used as the output voltage 351 at the USB output port 350. For example, from time t₀ to time t₁, the voltage 311 is equal to 9 volts, which is the value of the detected load demand voltage for the USB output port 350. As an example, from time t₀ to time t₁, the feedback voltage V_{FB1} is equal to the voltage value Vₐ of the reference voltage V_{REF1}. In certain examples, from time t₀ to time t₁, the DC-to-DC controller 440 remains receiving the reference voltage V_{REF2}, a voltage that represents the reference current I_{REF2}, and a voltage that represents the feedback current I_{FB2}, remains obtaining the feedback voltage V_{FB2}, and generates the signal 389 based on at least information associated with the reference voltage V_{REF2}, the reference current I_{REF2}, the feedback current I_{FB2} and the feedback voltage V_{FB2}, and the DC-to-DC converter, which includes the capacitor 360, the inductive coil 370, and the switch controller 380, generates the voltage 331 based on at least information associated with the reference voltage V_{REF2}, the reference current I_{REF2}, the feedback current I_{FB2} and the feedback voltage V_{FB2}, wherein the voltage 331 remains being used as the output voltage 353 at the USB output port 352. For example, from time t₀ to time t₁, the voltage 331 is equal to 5 volts, which is the value of the detected load demand voltage for the USB output port 352. As an example, from time t₀ to time t₁, the feedback voltage V_{FB2} is equal to the voltage value V_{b} of the reference voltage V_{REF2}.

In some embodiments, at time t₁, the detected load demand voltage for the USB output port 352 changes from 5 volts to 15 volts and becomes larger than the detected load demand voltage for the USB output port 350, wherein the detected load demand voltage for the USB output port 350 remains at 9 volts. In certain examples, at time t₁, the AC-to-DC controller 430 remains receiving the reference voltage V_{REF1}, a voltage that represents the reference current I_{REF1}, and a voltage that represents the feedback current I_{FB1}, remains obtaining the feedback voltage V_{FB1}, and generates the control signal 321 based on at least information associated with the reference voltage V_{REF1}, the reference current I_{REF1}, the feedback current I_{FB1} and the feedback voltage V_{FB1}, and the AC-to-DC converter 310 generates the voltage 311 (e.g., VIN) based on at least information associated with the reference voltage V_{REF1}, the reference current I_{REF1}, the feedback current I_{FB1} and the feedback voltage V_{FB1}, wherein the voltage 311 remains being used as the output voltage 351 at the USB output port 350. For example, at time t₁, the voltage 311 is equal to 9 volts, which is the value of the detected load demand voltage for the USB output port 350. As an example, at time t₁, the feedback voltage V_{FB1} is equal to the voltage value Vₐ of the reference voltage V_{REF1}. In some examples, at time t₁, the DC-to-DC controller 440 becomes receiving the reference voltage V_{REF1}, remains receiving a voltage that represents the reference current I_{REF2} and a voltage that represents the feedback current I_{FB2}, remains obtaining the feedback voltage V_{FB2}, and generates the signal 389 based on at least information associated with the reference voltage V_{REF1}, the reference current I_{REF2}, the feedback current I_{FB2} and the feedback voltage V_{FB2}, and the DC-to-DC converter, which includes the capacitor 360, the inductive coil 370, and the switch controller 380, generates the voltage 331 based on at least information associated with the reference voltage V_{REF1}, the reference current I_{REF2}, the feedback current I_{FB2} and the feedback voltage V_{FB2}, wherein the voltage 331 remains being used as the output voltage 353 at the USB output port 352. For example, at time t₁, the voltage 331 is equal to 5 volts, which is smaller than the value of the detected load demand voltage for the USB output port 350. As an example, at time t₁, the feedback voltage V_{FB2} is smaller than the voltage value Vₐ of the reference voltage V_{REF1}.

According to certain embodiments, from time t₁ to time t₂, as shown by the waveform 531, the voltage 331 increases with time in order to reach the detected load demand voltage for the USB output port 350, wherein the detected load demand voltage for the USB output port 350 remains equal to 9 volts. For example, from time t₁ to time t₂, as shown by the waveform 511, the voltage 311 (e.g., VIN) remains at 9 volts, which is equal to the detected load demand voltage for the USB output port 350. In some examples, from time t₁ to time t₂, the switch 340 is still closed (e.g., the transistor 340 is still turned on), the switch 342 is still open (e.g., the transistor 342 is still turned off), the switch 344 is still open (e.g., the transistor 344 is still turned off), and the switch 346 is still closed (e.g., the transistor 346 is turned on), so that the voltage 311 is still used as the output voltage 351 and the voltage 331 is still used as the output voltage 353. For example, from time t₁ to time t₂, as shown by the waveform 553, the output voltage 353 increases with time to reach the detected load demand voltage for the USB output port 350, wherein the detected load demand voltage for the USB output port 350 remains equal to 9 volts. As an example, from time t₁ to time t₂, as shown by the waveform 551, the output voltage 351 remains equal to 9 volts, which is the value of the detected load demand voltage for the USB output port 350. In certain examples, from time t₁ to time t₂, the AC-to-DC controller 430 remains receiving the reference voltage V_{REF1}, a voltage that represents the reference current I_{REF1}, and a voltage that represents the feedback current I_{FB1}, remains obtaining the feedback voltage V_{FB1}, and generates the control signal 321 based on at least information associated with the reference voltage V_{REF1}, the reference current I_{REF1}, the feedback current I_{FB1} and the feedback voltage V_{FB1}, and the AC-to-DC converter 310 generates the voltage 311 (e.g., VIN) based on at least information associated with the reference voltage V_{REF1}, the reference current I_{REF1}, the feedback current I_{FB1} and the feedback voltage V_{FB1}, wherein the voltage 311 remains being used as the output voltage 351 at the USB output port 350. For example, from time t₁ to time t₂, the voltage 311 is equal to 9 volts, which is the value of the detected load demand voltage for the USB output port 350. As an example, from time t₁ to time t₂, the feedback voltage V_{FB1} is equal to the voltage value Vₐ of the reference voltage V_{REF1}. In some examples, from time t₁ to time t₂, the DC-to-DC controller 440 remains receiving the reference voltage V_{REF1}, a voltage that represents the reference current I_{REF2}, and a voltage that represents the feedback current I_{FB2}, remains obtaining the feedback voltage V_{FB2}, and generates the signal 389 based on at least information associated with the reference voltage V_{REF1}, the reference current I_{REF2}, the feedback current I_{FB2} and the feedback voltage V_{FB2}, and the DC-to-DC converter, which includes the capacitor 360, the inductive coil 370, and the switch controller 380, generates the voltage 331 based on at least information associated with the reference voltage V_{REF1}, the reference current I_{REF2}, the feedback current I_{FB2} and the feedback voltage V_{FB2}, wherein the voltage 331 remains being used as the output voltage 353 at the USB output port 352. For example, from time t₁ to time t₂, the voltage 331 increases with time in order to reach the value of the detected load demand voltage for the USB output port 350. As an example, from time t₁ to time t₂, the feedback voltage V_{FB2} increases with time in order to reach the voltage value Vₐ of the reference voltage V_{REF1}.

According to some embodiments, at time t₂, as shown by the waveform 531, the voltage 331 reaches the detected load demand voltage for the USB output port 350, wherein the detected load demand voltage for the USB output port 350 remains at 9 volts. For example, at time t₂, as shown by the waveform 511, the voltage 311 (e.g., VIN) is also equal to 9 volts, which is the value of the detected load demand voltage for the USB output port 350. As an example, at time t₂, the AC-to-DC controller 430 becomes receiving the reference voltage V_{REF2}, a voltage that represents the reference current I_{REF2}, and a voltage that represents the feedback current I_{FB2}, and becomes obtaining the feedback voltage V_{FB2}, and the DC-to-DC controller 440 remains receiving the reference voltage V_{REF1}, becomes receiving a voltage that represents the reference current I_{REF1} and a voltage that represents the feedback current I_{FB1}, and becomes receiving the feedback voltage V_{FB1}. In certain examples, at time t₂, the switch 342 becomes closed (e.g., the transistor 342 becomes turned on), the switch 340 becomes open (e.g., the transistor 340 becomes turned off), the switch 344 becomes closed (e.g., the transistor 344 becomes turned on), and the switch 346 becomes open (e.g., the transistor 346 becomes turned off), so that the voltage 311 becomes being used as the output voltage 353, and the voltage 331 becomes being used as the output voltage 351. In some examples, at time t₂, the AC-to-DC controller 430 becomes receiving the reference voltage V_{REF2}, a voltage that represents the reference current I_{REF2}, and a voltage that represents the feedback current I_{FB2}, becomes obtaining the feedback voltage V_{FB2}, and generates the control signal 321 based on at least information associated with the reference voltage V_{REF2}, the reference current I_{REF2}, the feedback current I_{FB2} and the feedback voltage V_{FB2}, and the AC-to-DC converter 310 generates the voltage 311 (e.g., VIN) based on at least information associated with the reference voltage V_{REF2}, the reference current I_{REF2}, the feedback current I_{FB2} and the feedback voltage V_{FB2}, wherein the voltage 311 becomes being used as the output voltage 353 at the USB output port 352. For example, at time t₂, the voltage 311 is equal to 9 volts, which is smaller than the value of the detected load demand voltage for the USB output port 352. As an example, at time t₂, the feedback voltage V_{FB2} is smaller than the voltage value V_{c} of the reference voltage V_{REF2}. In certain examples, at time t₂, the DC-to-DC controller 440 remains receiving the reference voltage V_{REF1}, becomes receiving a voltage that represents the reference current I_{REF1} and a voltage that represents the feedback current I_{FB1}, becomes obtaining the feedback voltage V_{FB1}, and generates the signal 389 based on at least information associated with the reference voltage V_{REF1}, the reference current I_{REF1}, the feedback current I_{FB1} and the feedback voltage V_{FB1}, and the DC-to-DC converter, which includes the capacitor 360, the inductive coil 370, and the switch controller 380, generates the voltage 331 based on at least information associated with the reference voltage V_{REF1}, the reference current I_{REF1}, the feedback current I_{FB1} and the feedback voltage V_{FB1}, wherein the voltage 331 becomes being used as the output voltage 351 at the USB output port 350. For example, at time t₂, the voltage 331 reaches the value of the detected load demand voltage for the USB output port 350. As an example, at time t₂, the feedback voltage V_{FB1} is equal to the voltage value Vₐ of the reference voltage V_{REF1}.

According to certain embodiments, from time t₂ to time t₃, as shown by the waveform 531, the voltage 331 remains equal to the detected load demand voltage for the USB output port 350, wherein the detected load demand voltage for the USB output port 350 remains equal to 9 volts. For example, from time t₂ to time t₃, as shown by the waveform 511, the voltage 311 (e.g., VIN) increases with time in order to reach the detected load demand voltage for the USB output port 352, wherein the detected load demand voltage for the USB output port 350 remains equal to 15 volts. In some examples, from time t₂ to time t₃, the switch 340 is open (e.g., the transistor 340 is turned off), the switch 342 is closed (e.g., the transistor 342 is turned on), the switch 344 is closed (e.g., the transistor 344 is turned on), and the switch 346 is open (e.g., the transistor 346 is turned off), so that the voltage 311 is used as the output voltage 353, and the voltage 331 is used as the output voltage 351. For example, from time t₂ to time t₃, as shown by the waveform 553, the output voltage 353, which is equal to the voltage 311 (e.g., VIN), also increases with time. As an example, from time t₂ to time t₃, as shown by the waveform 551, the output voltage 351, which is equal to the voltage 331, also remains equal to 9 volts, which is equal to the detected load demand voltage for the USB output port 350. In certain examples, from time t₂ to time t₃, the AC-to-DC controller 430 remains receiving the reference voltage V_{REF2}, a voltage that represents the reference current I_{REF2}, and a voltage that represents the feedback current I_{FB2}, remains obtaining the feedback voltage V_{FB2}, and generates the control signal 321 based on at least information associated with the reference voltage V_{REF2}, the reference current I_{REF2}, the feedback current I_{FB2} and the feedback voltage V_{FB2}, and the AC-to-DC converter 310 generates the voltage 311 (e.g., VIN) based on at least information associated with the reference voltage V_{REF2}, the reference current I_{REF2}, the feedback current I_{FB2} and the feedback voltage V_{FB2}, wherein the voltage 311 remains being used as the output voltage 353 at the USB output port 352. For example, from time t₂ to time t₃, the voltage 311 increases with time in order to reach the value of the detected load demand voltage for the USB output port 352. As an example, from time t₂ to time t₃, the feedback voltage V_{FB2} increases with time in order to reach the voltage value V_{c} of the reference voltage V_{REF2}. In some examples, from time t₂ to time t₃, the DC-to-DC controller 440 remains receiving the reference voltage V_{REF1}, a voltage that represents the reference current I_{REF1}, and a voltage that represents the feedback current I_{FB1}, remains obtaining the feedback voltage V_{FB1}, and generates the signal 389 based on at least information associated with the reference voltage V_{REF1}, the reference current I_{REF1}, the feedback current I_{FB1} and the feedback voltage V_{FB1}, and the DC-to-DC converter, which includes the capacitor 360, the inductive coil 370, and the switch controller 380, generates the voltage 331 based on at least information associated with the reference voltage V_{REF1}, the reference current I_{REF1}, the feedback current I_{FB1} and the feedback voltage V_{FB1}, wherein the voltage 331 remains being used as the output voltage 351 at the USB output port 350. For example, from time t₂ to time t₃, the voltage 331 is equal to 9 volts, which is the value of the detected load demand voltage for the USB output port 350. As an example, from time t₂ to time t₃, the feedback voltage V_{FB1} is equal to the voltage value Vₐ of the reference voltage V_{REF1}.

In some embodiments, at time t₃, as shown by the waveform 511, the voltage 311 (e.g., VIN) reaches the detected load demand voltage for the USB output port 352, wherein the detected load demand voltage for the USB output port 352 is equal to 15 volts. For example, at time t₃, as shown by the waveform 531, the voltage 331 is equal to 9 volts, which is the value of the detected load demand voltage for the USB output port 350. In certain examples, at time t₃, the switch 340 is still open (e.g., the transistor 340 is still turned off), the switch 342 is still closed (e.g., the transistor 342 is still turned on), the switch 344 is still closed (e.g., the transistor 344 is still turned on), and the switch 346 is still open (e.g., the transistor 346 is still turned off), so that the voltage 311 remains being used as the output voltage 353, and the voltage 331 remains being used as the output voltage 351. In some examples, at time t₃, the AC-to-DC controller 430 remains receiving the reference voltage V_{REF2}, a voltage that represents the reference current I_{REF2}, and a voltage that represents the feedback current I_{FB2}, remains obtaining the feedback voltage V_{FB2}, and generates the control signal 321 based on at least information associated with the reference voltage V_{REF2}, the reference current I_{REF2}, the feedback current I_{FB2} and the feedback voltage V_{FB2}, and the AC-to-DC converter 310 generates the voltage 311 (e.g., VIN) based on at least information associated with the reference voltage V_{REF2}, the reference current I_{REF2}, the feedback current I_{FB2} and the feedback voltage V_{FB2}, wherein the voltage 311 remains being used as the output voltage 353 at the USB output port 352. For example, at time t₃, the voltage 311 reaches the value of the detected load demand voltage for the USB output port 352. As an example, at time t₃, the feedback voltage V_{FB2} reaches the voltage value V_{c} of the reference voltage V_{REF2}. In certain examples, at time t₃, the DC-to-DC controller 440 remains receiving the reference voltage V_{REF1}, a voltage that represents the reference current I_{REF1}, and a voltage that represents the feedback current I_{FB1}, remains obtaining the feedback voltage V_{FB1}, and generates the signal 389 based on at least information associated with the reference voltage V_{REF1}, the reference current I_{REF1}, the feedback current I_{FB1} and the feedback voltage V_{FB1}, and the DC-to-DC converter, which includes the capacitor 360, the inductive coil 370, and the switch controller 380, generates the voltage 331 based on at least information associated with the reference voltage V_{REF1}, the reference current I_{REF1}, the feedback current I_{FB1} and the feedback voltage V_{FB1}, wherein the voltage 331 remains being used as the output voltage 351 at the USB output port 350. For example, at time t₃, the voltage 331 is equal to 9 volts, which is the value of the detected load demand voltage for the USB output port 350. As an example, at time t₃, the feedback voltage V_{FB1} is equal to the voltage value Vₐ of the reference voltage V_{REF1}.

In certain embodiments, after time t₃, as shown by the waveform 511, the voltage 311 (e.g., VIN) remains equal to 15 volts, which is the value of the detected load demand voltage for the USB output port 352. For example, after time t₃, as shown by the waveform 531, the voltage 331 remains equal to 9 volts, which is the value of the detected load demand voltage for the USB output port 350. In some examples, after time t₃, the switch 340 remains open (e.g., the transistor 340 remains turned off), the switch 342 remains closed (e.g., the transistor 342 remains turned on), the switch 344 remains closed (e.g., the transistor 344 remains turned on), and the switch 346 remains open (e.g., the transistor 346 remains turned off), so that the voltage 311 remains being used as the output voltage 353, and the voltage 331 remains being used as the output voltage 351. For example, after time t₃, as shown by the waveform 553, the output voltage 353 remains equal to 15 volts, which is the value of the detected load demand voltage for the USB output port 352. As an example, after time t₃, as shown by the waveform 551, the output voltage 351 remains equal to 9 volts, which is the value of the detected load demand voltage for the USB output port 350. In certain examples, after time t₃, the AC-to-DC controller 430 remains receiving the reference voltage V_{REF2}, a voltage that represents the reference current I_{REF2}, and a voltage that represents the feedback current I_{FB2}, remains obtaining the feedback voltage V_{FB2}, and generates the control signal 321 based on at least information associated with the reference voltage V_{REF2}, the reference current I_{REF2}, the feedback current I_{FB2} and the feedback voltage V_{FB2}, and the AC-to-DC converter 310 generates the voltage 311 (e.g., VIN) based on at least information associated with the reference voltage V_{REF2}, the reference current I_{REF2}, the feedback current I_{FB2} and the feedback voltage V_{FB2}, wherein the voltage 311 remains being used as the output voltage 353 at the USB output port 352. For example, after time t₃, the voltage 311 is equal to the value of the detected load demand voltage for the USB output port 352. As an example, after time t₃, the feedback voltage V_{FB2} is equal to the voltage value V_{c} of the reference voltage V_{REF2}. In certain examples, after time t₃, the DC-to-DC controller 440 remains receiving the reference voltage V_{REF1}, a voltage that represents the reference current I_{REF1}, and a voltage that represents the feedback current I_{FB1}, remains obtaining the feedback voltage V_{FB1}, and generates the signal 389 based on at least information associated with the reference voltage V_{REF1}, the reference current I_{REF1}, the feedback current I_{FB1} and the feedback voltage V_{FB1}, and the DC-to-DC converter, which includes the capacitor 360, the inductive coil 370, and the switch controller 380, generates the voltage 331 based on at least information associated with the reference voltage V_{REF1}, the reference current I_{REF1}, the feedback current I_{FB1} and the feedback voltage V_{FB1}, wherein the voltage 331 remains being used as the output voltage 351 at the USB output port 350. For example, after time t₃, the voltage 331 is equal to 9 volts, which is the value of the detected load demand voltage for the USB output port 350. As an example, after time t₃, the feedback voltage V_{FB1} is equal to the voltage value Vₐ of the reference voltage V_{REF1}.

Some embodiments of the present disclosure provide a two-port USB charging system, which can generate two output voltages that are used to fast charge two loads at two USB output ports respectively at the same time, wherein one output voltage of the two output voltages is generated by an AC-to-DC converter in response to at least a detected load demand voltage, and another output voltage of the two output voltages is generated by a DC-to-DC converter (e.g., a switching regulator unit) in response to at least another detected load demand voltage. For example, the two-port USB charging system does not implement power redundancy that can cause waste of extra physical size and/or extra costs. As an example, in order to reduce physical size and/or lower costs, the two-port USB charging system does not use two fast-charging control circuits, which correspond to two DC-to-DC converters (e.g., two switching regulator units). In certain examples, initially a first load is detected at a first USB output port but no load is detected at a second USB output port, and the two-port USB charging system provides a first output voltage to charge the first load; later, if a second load is detected at the second USB output port, the two-port USB charging system provides a second output voltage to the second load without changing the value of the first output voltage.

According to certain embodiments, a charging controller for a USB charging system includes: an AC-to-DC controller configured to generate a first signal and coupled to an AC-to-DC converter, the AC-to-DC converter being configured to convert an input voltage to a first converter voltage based on at least information associated with the first signal to output the first converter voltage as a first output voltage for a first USB output port or as a second output voltage for a second USB outport; and a DC-to-DC controller configured to generate a second signal and coupled to a DC-to-DC converter, the DC-to-DC converter being configured to convert the first converter voltage to a second converter voltage based on at least information associated with the second signal to output the second converter voltage as the second output voltage for the second USB outport or as the first output voltage for the first USB output port. For example, the charging controller is implemented according to at least FIG. 3 and/or FIG. 4.

As an example, the charging controller further includes a load demand detector coupled to the first USB output port and the second USB output port. For example, the load demand detector is configured to detect first load demand information for the first USB output port and generate a first reference voltage and a first reference current based at least in part on the first load demand information. As an example, the load demand detector is further configured to detect second load demand information for the second USB output port and generate a second reference voltage and a second reference current based at least in part on the second load demand information.

For example, the charging controller further includes a load current sampling unit coupled to the first USB output port and the second USB output port and configured to receive a third signal from the load demand detector. As an example, the load current sampling unit is configured to sample a first output current for the first USB output port and generate a first feedback current based at least in part on the sampled first output current. For example, the load current sampling unit is further configured to sample a second output current for the second USB output port and generate a second feedback current based at least in part on the sampled second output current.

As an example, the AC-to-DC controller is further configured to obtain a first feedback voltage based at least in part on the first output voltage for the first USB output port or obtain a second feedback voltage based at least in part on the second output voltage for the second USB output port; and the DC-to-DC controller is further configured to obtain the second feedback voltage based at least in part on the second output voltage for the second USB output port or obtain the first feedback voltage based at least in part on the first output voltage for the first USB output port.

For example, the charging controller further includes: a load demand detector configured to generate a first reference voltage and a first reference current based at least in part on first load demand information for the first USB output port and generate a second reference voltage and a second reference current based at least in part on second load demand information for the second USB output port; and a load current sampling unit configured to generate a first feedback current based at least in part on a first output current for the first USB output port and generate a second feedback current based at least in part on a second output current for the second USB output port. As an example, the AC-to-DC controller is further configured to generate the first signal based on at least information associated with the first reference voltage, the first reference current, the first feedback voltage and the first feedback current, the AC-to-DC controller being coupled to the AC-to-DC converter that is further configured to generate the first converter voltage based on at least information associated with the first signal to output the first converter voltage as the first output voltage for the first USB output port; and the DC-to-DC controller is further configured to generate the second signal based on at least information associated with the second reference voltage, the second reference current, the second feedback voltage and the second feedback current, the DC-to-DC controller being coupled to the DC-to-DC converter that is further configured to generate the second converter voltage based on at least information associated with the second signal to output the second converter voltage as the second output voltage for the second USB output port. For example, the AC-to-DC controller is further configured to generate the first signal based on at least information associated with the first reference voltage, the first reference current, the first feedback voltage and the first feedback current, the AC-to-DC controller being coupled to the AC-to-DC converter that is further configured to generate the first converter voltage based on at least information associated with the first signal to output the first converter voltage as the first output voltage for the first USB output port; and the DC-to-DC controller is further configured to generate the second signal based on at least information associated with the first reference voltage, the second reference current, the second feedback voltage and the second feedback current, the DC-to-DC controller being coupled to the DC-to-DC converter that is further configured to generate the second converter voltage based on at least information associated with the second signal to output the second converter voltage as the second output voltage for the second USB output port. As an example, the AC-to-DC controller is further configured to generate the first signal based on at least information associated with the second reference voltage, the second reference current, the second feedback voltage and the second feedback current, the AC-to-DC controller being coupled to the AC-to-DC converter that is further configured to generate the first converter voltage based on at least information associated with the first signal to output the first converter voltage as the second output voltage for the second USB output port; and the DC-to-DC controller is further configured to generate the second signal based on at least information associated with the first reference voltage, the first reference current, the first feedback voltage and the first feedback current, the DC-to-DC controller being coupled to the DC-to-DC converter that is further configured to generate the second converter voltage based on at least information associated with the second signal to output the second converter voltage as the first output voltage for the first USB output port.

As an example, the second converter voltage is less than or equal to the first converter voltage. For example, the AC-to-DC controller is coupled to the AC-to-DC converter through an optocoupler.

According to some embodiments, a charging controller for a USB charging system includes: an AC-to-DC controller configured to generate a first signal and coupled to an AC-to-DC converter configured to convert an input voltage to a first converter voltage based on at least information associated with the first signal; a DC-to-DC controller configured to generate a second signal and coupled to a DC-to-DC converter configured to convert the first converter voltage to a second converter voltage based on at least information associated with the second signal; a load demand detector coupled to the AC-to-DC controller and the DC-to-DC controller and also coupled to a first USB output port and a second USB output port, the load demand detector being configured to detect first load demand information for the first USB output port and generate a first reference voltage and a first reference current based at least in part on the first load demand information and being further configured to detect second load demand information for the second USB output port and generate a second reference voltage and a second reference current based at least in part on the second load demand information; and a load current sampling unit coupled to the AC-to-DC controller and the DC-to-DC controller and also coupled to the first USB output port and the second USB output port, the load current sampling unit being configured to receive a third signal from the load demand detector, the load current sampling unit being configured to sample a first output current for the first USB output port and generate a first feedback current based at least in part on the sampled first output current and further configured to sample a second output current for the second USB output port and generate a second feedback current based at least in part on the sampled second output current. For example, the charging controller is implemented according to at least FIG. 3 and/or FIG. 4.

As an example, in response to the first reference voltage being larger than the second reference voltage, the AC-to-DC controller is further configured to generate the first signal based on at least information associated with the first reference voltage, the first reference current, the first feedback voltage and the first feedback current, the AC-to-DC controller being coupled to the AC-to-DC converter that is further configured to generate the first converter voltage to output the first converter voltage as the first output voltage for the first USB output port; and the DC-to-DC controller is further configured to generate the second signal based on at least information associated with the second reference voltage, the second reference current, the second feedback voltage and the second feedback current, the DC-to-DC controller being coupled to the DC-to-DC converter that is further configured to generate the second converter voltage to output the second converter voltage as the second output voltage for the second USB output port. For example, in response to the second reference voltage becoming larger than the first reference voltage, the AC-to-DC controller is further configured to generate the first signal based on at least information associated with the first reference voltage, the first reference current, the first feedback voltage and the first feedback current, the AC-to-DC controller being coupled to the AC-to-DC converter that is further configured to generate the first converter voltage to output the first converter voltage as the first output voltage for the first USB output port; and the DC-to-DC controller is further configured to generate the second signal based on at least information associated with the first reference voltage, the second reference current, the second feedback voltage and the second feedback current, the DC-to-DC controller being coupled to the DC-to-DC converter that is further configured to generate the second converter voltage to output the second converter voltage as the second output voltage for the second USB output port. As an example, in response to the second reference voltage becoming larger than the first reference voltage, the first output voltage remains constant with time; and the second output voltage increases with time. For example, in response to the second output voltage reaching the first output voltage, the AC-to-DC controller is further configured to generate the first signal based on at least information associated with the second reference voltage, the second reference current, the second feedback voltage and the second feedback current, the AC-to-DC controller being coupled to the AC-to-DC converter that is further configured to generate the first converter voltage to output the first converter voltage as the second output voltage for the second USB output port; and the DC-to-DC controller is further configured to generate the second signal based on at least information associated with the first reference voltage, the first reference current, the first feedback voltage and the first feedback current, the DC-to-DC controller being coupled to the DC-to-DC converter that is further configured to generate the second converter voltage to output the second converter voltage as the first output voltage for the first USB output port. As an example, in response to the second output voltage reaching the first output voltage, the first output voltage remains constant with time; and the second output voltage increases with time.

According to certain embodiments, a USB charging system includes: a first USB output port; a second USB output port; a charging controller including an AC-to-DC controller and a DC-to-DC controller; an AC-to-DC converter coupled to the AC-to-DC controller; a DC-to-DC converter coupled to the DC-to-DC controller; a plurality of first switches coupled to the first USB output port; and a plurality of second switches coupled to the second USB output port; wherein: the AC-to-DC controller is configured to generate a first signal; and the DC-to-DC controller is configured to generate a second signal; wherein: the AC-to-DC converter is configured to convert an input voltage to a first converter voltage based on at least information associated with the first signal; and the DC-to-DC converter is configured to convert the first converter voltage to a second converter voltage based on at least information associated with the second signal; wherein: the plurality of first switches is configured to output the first converter voltage as a first output voltage for the first USB output port through a switch of the plurality of first switches; and the plurality of second switches is configured to output the second converter voltage as a second output voltage for the second USB output port through a switch of the plurality of second switches; wherein: the plurality of second switches is further configured to output the first converter voltage as the second output voltage for the second USB output port through another switch of the plurality of second switches; and the plurality of first switches is further configured to output the second converter voltage as the first output voltage for the first USB output port through another switch of the plurality of first switches. For example, the USB charging system is implemented according to at least FIG. 3 and/or FIG. 4.

As an example, the charging controller further includes a load demand detector coupled to the first USB output port and the second USB output port. For example, the load demand detector is configured to detect first load demand information for the first USB output port and generate a first reference voltage and a first reference current based at least in part on the first load demand information. As an example, the load demand detector is further configured to detect second load demand information for the second USB output port and generate a second reference voltage and a second reference current based at least in part on the second load demand information. For example, the charging controller further includes a load current sampling unit coupled to the first USB output port and the second USB output port and configured to receive a third signal from the load demand detector. As an example, the load current sampling unit is configured to sample a first output current for the first USB output port and generate a first feedback current based at least in part on the sampled first output current. For example, the load current sampling unit is further configured to sample a second output current for the second USB output port and generate a second feedback current based at least in part on the sampled second output current. As an example, the second converter voltage is less than or equal to the first converter voltage. For example, the USB charging system further includes an optocoupler coupled to the AC-to-DC controller and the AC-to-DC converter.

According to some embodiments, a USB charging system includes: a first USB output port; a second USB output port; a charging controller including an AC-to-DC controller, a DC-to-DC controller, a load demand detector, and a load current sampling unit; an AC-to-DC converter coupled to the AC-to-DC controller; and a DC-to-DC converter coupled to the DC-to-DC controller; wherein: the AC-to-DC controller is configured to generate a first signal; and the DC-to-DC controller is configured to generate a second signal; wherein: the AC-to-DC converter is configured to convert an input voltage to a first converter voltage based on at least information associated with the first signal to output the first converter voltage as a first output voltage to the first USB output port or output the first converter voltage as a second output voltage to the second USB output port; and the DC-to-DC converter is configured to convert the first converter voltage to a second converter voltage based on at least information associated with the second signal to output the second converter voltage as the second output voltage to the second USB output port or output the second converter voltage as the first output voltage to the first USB output port; wherein: the load demand detector is coupled to the AC-to-DC controller and the DC-to-DC controller and also coupled to the first USB output port and the second USB output port; and the load current sampling unit is coupled to the AC-to-DC controller and the DC-to-DC controller and also coupled to the first USB output port and the second USB output port; wherein the load demand detector is configured to: detect first load demand information for the first USB output port; generate a first reference voltage and a first reference current based at least in part on the first load demand information; detect second load demand information for the second USB output port; and generate a second reference voltage and a second reference current based at least in part on the second load demand information; wherein the load current sampling unit is configured to: receive a third signal from the load demand detector; sample a first output current for the first USB output port; generate a first feedback current based at least in part on the sampled first output current; sample a second output current for the second USB output port; and generate a second feedback current based at least in part on the sampled second output current. For example, the USB charging system is implemented according to at least FIG. 3 and/or FIG. 4.

According to certain embodiments, a method for a charging controller of a USB charging system includes: generating a first signal to convert an input voltage to a first converter voltage based on at least information associated with the first signal to output the first converter voltage as a first output voltage for a first USB output port or as a second output voltage for a second USB outport; and generating a second signal to convert the first converter voltage to a second converter voltage based on at least information associated with the second signal to output the second converter voltage as the second output voltage for the second USB outport or as the first output voltage for the first USB output port. For example, the method is implemented according to at least FIG. 3 and/or FIG. 4. As an example, the input voltage is an AC voltage. For example, the second converter voltage is less than or equal to the first converter voltage.

For example, some or all components of various embodiments of the present disclosure each are, individually and/or in combination with at least another component, implemented using one or more software components, one or more hardware components, and/or one or more combinations of software and hardware components. As an example, some or all components of various embodiments of the present disclosure each are, individually and/or in combination with at least another component, implemented in one or more circuits, such as one or more analog circuits and/or one or more digital circuits. For example, various embodiments and/or examples of the present disclosure can be combined.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments.

What is claimed is:

1. A charging controller for a USB charging system, the charging controller comprising:
an AC-to-DC controller configured to generate a first signal and coupled to an AC-to-DC converter, the AC-to-DC converter being configured to convert an input voltage to a first converter voltage based on at least information associated with the first signal to output the first converter voltage as a first output voltage for a first USB output port or as a second output voltage for a second USB outport; and
a DC-to-DC controller configured to generate a second signal and coupled to a DC-to-DC converter, the DC-to-DC converter being configured to convert the first converter voltage to a second converter voltage based on at least information associated with the second signal to output the second converter voltage as the second output voltage for the second USB outport or as the first output voltage for the first USB output port.

2. The charging controller of claim 1, and further comprising a load demand detector coupled to the first USB output port and the second USB output port.

3. The charging controller of claim 2 wherein the load demand detector is configured to detect first load demand information for the first USB output port and generate a first reference voltage and a first reference current based at least in part on the first load demand information.

4. The charging controller of claim 3 wherein the load demand detector is further configured to detect second load demand information for the second USB output port and generate a second reference voltage and a second reference current based at least in part on the second load demand information.

5. The charging controller of claim 2, and further comprising a load current sampling unit coupled to the first USB output port and the second USB output port and configured to receive a third signal from the load demand detector.

6. The charging controller of claim 5 wherein the load current sampling unit is configured to sample a first output current for the first USB output port and generate a first feedback current based at least in part on the sampled first output current.

7. The charging controller of claim 6 wherein the load current sampling unit is further configured to sample a second output current for the second USB output port and generate a second feedback current based at least in part on the sampled second output current.

8. The charging controller of claim 1 wherein:
the AC-to-DC controller is further configured to obtain a first feedback voltage based at least in part on the first output voltage for the first USB output port or obtain a second feedback voltage based at least in part on the second output voltage for the second USB output port; and
the DC-to-DC controller is further configured to obtain the second feedback voltage based at least in part on the second output voltage for the second USB output port or obtain the first feedback voltage based at least in part on the first output voltage for the first USB output port.

9. The charging controller of claim 8, and further comprising:
a load demand detector configured to generate a first reference voltage and a first reference current based at least in part on first load demand information for the first USB output port and generate a second reference voltage and a second reference current based at least in part on second load demand information for the second USB output port; and
a load current sampling unit configured to generate a first feedback current based at least in part on a first output current for the first USB output port and generate a second feedback current based at least in part on a second output current for the second USB output port.

10. The charging controller of claim 9 wherein:
the AC-to-DC controller is further configured to generate the first signal based on at least information associated with the first reference voltage, the first reference current, the first feedback voltage and the first feedback current, the AC-to-DC controller being coupled to the AC-to-DC converter that is further configured to generate the first converter voltage based on at least information associated with the first signal to output the first converter voltage as the first output voltage for the first USB output port; and
the DC-to-DC controller is further configured to generate the second signal based on at least information associated with the second reference voltage, the second reference current, the second feedback voltage and the second feedback current, the DC-to-DC controller being coupled to the DC-to-DC converter that is further configured to generate the second converter voltage based on at least information associated with the second signal to output the second converter voltage as the second output voltage for the second USB output port.

11. The charging controller of claim 10 wherein:
the AC-to-DC controller is further configured to generate the first signal based on at least information associated with the first reference voltage, the first reference current, the first feedback voltage and the first feedback current, the AC-to-DC controller being coupled to the AC-to-DC converter that is further configured to generate the first converter voltage based on at least information associated with the first signal to output the first converter voltage as the first output voltage for the first USB output port; and
the DC-to-DC controller is further configured to generate the second signal based on at least information associated with the first reference voltage, the second reference current, the second feedback voltage and the second feedback current, the DC-to-DC controller being coupled to the DC-to-DC converter that is further configured to generate the second converter voltage based on at least information associated with the second signal to output the second converter voltage as the second output voltage for the second USB output port.

12. The charging controller of claim 11 wherein:
the AC-to-DC controller is further configured to generate the first signal based on at least information associated with the second reference voltage, the second reference current, the second feedback voltage and the second feedback current, the AC-to-DC controller being coupled to the AC-to-DC converter that is further configured to generate the first converter voltage based on at least information associated with the first signal to output the first converter voltage as the second output voltage for the second USB output port; and
the DC-to-DC controller is further configured to generate the second signal based on at least information associated with the first reference voltage, the first reference current, the first feedback voltage and the first feedback current, the DC-to-DC controller being coupled to the DC-to-DC converter that is further configured to generate the second converter voltage based on at least information associated with the second signal to output the second converter voltage as the first output voltage for the first USB output port.

13. The charging controller of claim 1 wherein the second converter voltage is less than or equal to the first converter voltage.

14. The charging controller of claim 1 wherein the AC-to-DC controller is coupled to the AC-to-DC converter through an optocoupler.

15. A charging controller for a USB charging system, the charging controller comprising:
an AC-to-DC controller configured to generate a first signal and coupled to an AC-to-DC converter configured to convert an input voltage to a first converter voltage based on at least information associated with the first signal;
a DC-to-DC controller configured to generate a second signal and coupled to a DC-to-DC converter configured to convert the first converter voltage to a second converter voltage based on at least information associated with the second signal;
a load demand detector coupled to the AC-to-DC controller and the DC-to-DC controller and also coupled to a first USB output port and a second USB output port, the load demand detector being configured to detect first load demand information for the first USB output port and generate a first reference voltage and a first reference current based at least in part on the first load demand information and being further configured to detect second load demand information for the second USB output port and generate a second reference voltage and a second reference current based at least in part on the second load demand information; and
a load current sampling unit coupled to the AC-to-DC controller and the DC-to-DC controller and also coupled to the first USB output port and the second USB output port, the load current sampling unit being configured to receive a third signal from the load demand detector, the load current sampling unit being configured to sample a first output current for the first USB output port and generate a first feedback current based at least in part on the sampled first output current and further configured to sample a second output current for the second USB output port and generate a second feedback current based at least in part on the sampled second output current.

16. The charging controller of claim 15 wherein:
in response to the first reference voltage being larger than the second reference voltage,
the AC-to-DC controller is further configured to generate the first signal based on at least information associated with the first reference voltage, the first reference current, the first feedback voltage and the first feedback current, the AC-to-DC controller being coupled to the AC-to-DC converter that is further configured to generate the first converter voltage to output the first converter voltage as the first output voltage for the first USB output port; and
the DC-to-DC controller is further configured to generate the second signal based on at least information associated with the second reference voltage, the second reference current, the second feedback voltage and the second feedback current, the DC-to-DC controller being coupled to the DC-to-DC converter that is further configured to generate the second converter voltage to output the second converter voltage as the second output voltage for the second USB output port.

17. The charging controller of claim 16 wherein:
in response to the second reference voltage becoming larger than the first reference voltage,
the AC-to-DC controller is further configured to generate the first signal based on at least information associated with the first reference voltage, the first reference current, the first feedback voltage and the first feedback current, the AC-to-DC controller being coupled to the AC-to-DC converter that is further configured to generate the first converter voltage to output the first converter voltage as the first output voltage for the first USB output port; and
the DC-to-DC controller is further configured to generate the second signal based on at least information associated with the first reference voltage, the second reference current, the second feedback voltage and the second feedback current, the DC-to-DC controller being coupled to the DC-to-DC converter that is further configured to generate the second converter voltage to output the second converter voltage as the second output voltage for the second USB output port.

18. The charging controller of claim 17 wherein:
in response to the second reference voltage becoming larger than the first reference voltage,
the first output voltage remains constant with time; and
the second output voltage increases with time.

19. The charging controller of claim 18 wherein:
in response to the second output voltage reaching the first output voltage,
the AC-to-DC controller is further configured to generate the first signal based on at least information associated with the second reference voltage, the second reference current, the second feedback voltage and the second feedback current, the AC-to-DC controller being coupled to the AC-to-DC converter that is further configured to generate the first converter voltage to output the first converter voltage as the second output voltage for the second USB output port; and
the DC-to-DC controller is further configured to generate the second signal based on at least information associated with the first reference voltage, the first reference current, the first feedback voltage and the first feedback current, the DC-to-DC controller being coupled to the DC-to-DC converter that is further configured to generate the second converter voltage to output the second converter voltage as the first output voltage for the first USB output port.

20. The charging controller of claim 19 wherein:
in response to the second output voltage reaching the first output voltage,
the first output voltage remains constant with time; and
the second output voltage increases with time.

21. A USB charging system comprising:
a first USB output port;
a second USB output port;
a charging controller including an AC-to-DC controller and a DC-to-DC controller;
an AC-to-DC converter coupled to the AC-to-DC controller;
a DC-to-DC converter coupled to the DC-to-DC controller;
a plurality of first switches coupled to the first USB output port; and
a plurality of second switches coupled to the second USB output port;
wherein:
the AC-to-DC controller is configured to generate a first signal; and
the DC-to-DC controller is configured to generate a second signal;
wherein:
the AC-to-DC converter is configured to convert an input voltage to a first converter voltage based on at least information associated with the first signal; and
the DC-to-DC converter is configured to convert the first converter voltage to a second converter voltage based on at least information associated with the second signal;
wherein:
the plurality of first switches is configured to output the first converter voltage as a first output voltage for the first USB output port through a switch of the plurality of first switches; and
the plurality of second switches is configured to output the second converter voltage as a second output voltage for the second USB output port through a switch of the plurality of second switches;
wherein:
the plurality of second switches is further configured to output the first converter voltage as the second output voltage for the second USB output port through another switch of the plurality of second switches; and
the plurality of first switches is further configured to output the second converter voltage as the first output voltage for the first USB output port through another switch of the plurality of first switches.

22. The USB charging system of claim 21 wherein the charging controller further includes a load demand detector coupled to the first USB output port and the second USB output port.

23. The USB charging system of claim 22 wherein the load demand detector is configured to detect first load demand information for the first USB output port and generate a first reference voltage and a first reference current based at least in part on the first load demand information.

24. The USB charging system of claim 23 wherein the load demand detector is further configured to detect second load demand information for the second USB output port and generate a second reference voltage and a second reference current based at least in part on the second load demand information.

25. The USB charging system of claim 22 wherein the charging controller further includes a load current sampling unit coupled to the first USB output port and the second USB output port and configured to receive a third signal from the load demand detector.

26. The USB charging system of claim 25 wherein the load current sampling unit is configured to sample a first output current for the first USB output port and generate a first feedback current based at least in part on the sampled first output current.

27. The USB charging system of claim 26 wherein the load current sampling unit is further configured to sample a second output current for the second USB output port and generate a second feedback current based at least in part on the sampled second output current.

28. The USB charging system of claim 21 wherein the second converter voltage is less than or equal to the first converter voltage.

29. The USB charging system of claim 21, and further comprising an optocoupler coupled to the AC-to-DC controller and the AC-to-DC converter.

30. A USB charging system comprising:
a first USB output port;
a second USB output port;
a charging controller including an AC-to-DC controller, a DC-to-DC controller, a load demand detector, and a load current sampling unit;
an AC-to-DC converter coupled to the AC-to-DC controller; and
a DC-to-DC converter coupled to the DC-to-DC controller;
wherein:
the AC-to-DC controller is configured to generate a first signal; and
the DC-to-DC controller is configured to generate a second signal;
wherein:
the AC-to-DC converter is configured to convert an input voltage to a first converter voltage based on at least information associated with the first signal to output the first converter voltage as a first output voltage to the first USB output port or output the first converter voltage as a second output voltage to the second USB output port; and
the DC-to-DC converter is configured to convert the first converter voltage to a second converter voltage based on at least information associated with the second signal to output the second converter voltage as the second output voltage to the second USB output port or output the second converter voltage as the first output voltage to the first USB output port;
wherein:
the load demand detector is coupled to the AC-to-DC controller and the DC-to-DC controller and also coupled to the first USB output port and the second USB output port; and
the load current sampling unit is coupled to the AC-to-DC controller and the DC-to-DC controller and also coupled to the first USB output port and the second USB output port;
wherein the load demand detector is configured to:
detect first load demand information for the first USB output port;
generate a first reference voltage and a first reference current based at least in part on the first load demand information;
detect second load demand information for the second USB output port; and
generate a second reference voltage and a second reference current based at least in part on the second load demand information;
wherein the load current sampling unit is configured to:
receive a third signal from the load demand detector;
sample a first output current for the first USB output port;
generate a first feedback current based at least in part on the sampled first output current;
sample a second output current for the second USB output port; and
generate a second feedback current based at least in part on the sampled second output current.

31. A method for a charging controller of a USB charging system, the method comprising:
generating a first signal to convert an input voltage to a first converter voltage based on at least information associated with the first signal to output the first converter voltage as a first output voltage for a first USB output port or as a second output voltage for a second USB outport; and
generating a second signal to convert the first converter voltage to a second converter voltage based on at least information associated with the second signal to output the second converter voltage as the second output voltage for the second USB outport or as the first output voltage for the first USB output port.

32. The method of claim 31 wherein the input voltage is an AC voltage.

33. The method of claim 31 wherein the second converter voltage is less than or equal to the first converter voltage.
